(19) United States
(12) Patent Application Publication
(10) Pub. No.: US 2024/0203167 A1
(43) Pub. Date: Jun. 20, 2024

(54) SYSTEM AND METHOD FOR COMMUNICATING MOTORING BATTERY INFORMATION WITHIN A GROUP OF ELECTRIC VEHICLES

(71) Applicant: TAIGA MOTORS INC., Lasalle (CA)

(72) Inventors: David-Emmanuel GADOURY, Montreal (CA); Jean-Philippe LANDRY, Terrebonne (CA); Rodrigo ARRAMBIDE, Montreal (CA); Mackenzie MURRAY, Montreal (CA)

(21) Appl. No.: 18/523,304

(22) Filed: Nov. 29, 2023

Related U.S. Application Data
(60) Provisional application No. 63/433,127, filed on Dec. 16, 2022.

(51) Int. Cl. G07C 5/00; B60L 15/20; B60L 58/12; G07C 5/08

(52) U.S. Cl. CPC G07C 5/004; B60L 15/2045; B60L 58/12; G07C 5/008; G07C 5/0825

(57) ABSTRACT

A method of facilitating an operation of a first electric vehicle of a group of electric vehicles, the method includes: determining, by a battery management system of a first motoring battery of the first electric vehicle, first motoring battery information indicating discharge of the first motoring battery over a first period of time during which the first electric vehicle is operational; receiving at least one wireless communication including second motoring battery information for a second motoring battery of a second electric vehicle of the group, the second motoring battery information indicating discharge of the second motoring battery over a second period of time during which the second electric vehicle is operational; and displaying a graphical interface on a display associated with the first electric vehicle, the graphical interface presenting the first motoring battery information and the second motoring battery information in real-time.

### CROSS-REFERENCE TO RELATED APPLICATIONS

This application claims priority from U.S. Provisional Patent Application No. 63/433,127, filed Dec. 16, 2022, which is incorporated by reference in its entirety herein.

### TECHNICAL FIELD

The application relates generally to electric vehicles and, more particularly, to systems and methods for facilitating operation of electric vehicles.

### BACKGROUND

Powersport vehicles such as snowmobiles, personal watercrafts, and all-terrain vehicles are widely used and are driven on routes including off-road trails. When riding in a group comprising a plurality of powersport vehicles, each vehicle of the group may have a respective estimated remaining range and may consume energy at a respective rate. For instance, drivers having a more aggressive driving style may see their remaining energy decrease more rapidly than other drivers. This may result in situation where one driver must stop before the others. Improvement is therefore desirable.

### SUMMARY

In one aspect, there is provided a method of facilitating an operation of a first electric vehicle of a group of electric vehicles, the method comprising: determining, by a battery management system of a first motoring battery of the first electric vehicle, first motoring battery information indicating discharge of the first motoring battery over a first period of time during which the first electric vehicle is operational; receiving at least one wireless communication including second motoring battery information for a second motoring battery of a second electric vehicle of the group, the second motoring battery information indicating discharge of the second motoring battery over a second period of time during which the second electric vehicle is operational; and displaying a graphical interface on a display associated with the first electric vehicle, the graphical interface presenting the first motoring battery information and the second motoring battery information in real-time.

The method described above may include any of the following features, in any combinations.

In some embodiments, the displaying of the graphical interface on the display associated with the first electric vehicle includes plotting, on the display, a first curve illustrating the discharge of the first motoring battery and plotting, on the display, a second curve illustrating the discharge of the second motoring battery over time.

In some embodiments, the displaying of the graphical interface on the display associated with the first electric vehicle includes displaying the first motoring battery information and the second motoring battery information on a display of the first electric vehicle.

In some embodiments, the displaying of the graphical interface on the display associated with the first electric vehicle includes displaying the first motoring battery information and the second motoring battery information on a personal electronic device of an operator of the first electric vehicle.

In some embodiments, the method includes transmitting the first motoring battery information to the group of electric vehicles.

In some embodiments, the transmitting of the first motoring battery information to the group of electric vehicles includes transmitting the first motoring battery information to the group of electric vehicles through a server remote from the group of electric vehicles.

In some embodiments, the transmitting of the first motoring battery information to the group of electric vehicles includes transmitting the first motoring battery information to the group of electric vehicles through a wireless connection defined between the electric vehicles of the group of electric vehicles.

In some embodiments, the first period of time at least partially overlaps with the second period of time.

In some embodiments, the method includes: determining, by the battery management system, third motoring battery information indicating discharge of the first motoring battery over a third period of time during which the first electric vehicle is operational, the third period of time occurring after the first period of time; receiving at least one further wireless communication including fourth motoring battery information for the second motoring battery indicating discharge of the second motoring battery over a fourth period of time, the fourth period of time occurring after the second period of time; and displaying an updated graphical interface on the display associated with the first electric vehicle, the updated graphical interface instantaneously presenting the first motoring battery information, the second motoring battery information, the third motoring battery information, and the fourth motoring battery information.

In some embodiments, the first motoring battery has a first battery capacity and the second motoring battery has a second battery capacity different from the first battery capacity; and the first motoring battery information is based on the first battery capacity and the second motoring battery information is based on the second battery capacity.

In some embodiments, the method includes receiving, from an operator interface of the first electric vehicle, a request to join the group of electric vehicles.

In some embodiments, the request to join the group of electric vehicles comprises an identifier of the group.

In some embodiments, the request to join the group of electric vehicles comprises an identifier of another electric vehicle in the group.

In some embodiments, the first motoring battery information includes one or more of a first current state of charge (SoC) of the first motoring battery and a first remaining range available with the first electric vehicle at the first current SoC, the second motoring battery information includes one or more of a second current state of charge (SoC) of the second motoring battery and a second remaining range available with the second electric vehicle at the second current SoC.

In some embodiments, the method includes one or more of: alerting the operator when the first current SoC differs from the second SoC by a SoC difference greater than a first threshold, and alerting the operator when the first remaining range differs from the second remaining range by a range difference greater than a second threshold.

In some embodiments, the alerting of the operator includes proposing to the operator to switch a driving mode of the first electric vehicle from a current driving mode to an extended range driving mode.

In some embodiments, the method includes computing the first remaining range of the first electric vehicle as a function of the first current SoC and a first distance travelled by the first electric vehicle during a trip with the group.

In some embodiments, the method includes computing the second remaining range of the second electric vehicle as a function of the second SoC and a second distance travelled by the second electric vehicle during a trip with the group.

In some embodiments, the method includes determining first predicted motoring battery information of the first motoring battery, the first predicted motoring battery information indicating predicted discharge of the first motoring battery over a first future period of time based on the first motoring battery information, wherein the graphical interface further presents the first predicted motoring battery information.

In some embodiments, the method includes determining second predicted motoring battery information of the second motoring battery, the second predicted motoring battery information indicating predicted discharge of the second motoring battery over a second future period of time based on the second motoring battery information, wherein the graphical interface further presents the second predicted motoring battery information.

In some embodiments, the first predicted motoring battery information indicates a range of predicted discharge of the first motoring battery over the first future period of time based on the first motoring battery information.

In another aspect, there is provided an electric vehicle comprising: a display; a first motoring battery; an electric motor for propelling the electric vehicle, the electric motor being operatively connected to be driven by electric power from the first motoring battery; one or more data processors operatively connected to the display, the first motoring battery, and to the electric motor; and a non-transitory machine-readable memory storing instructions executable by the one or more data processors and configured to cause the one or more data processors to: determine first motoring battery information indicating discharge of the first motoring battery over a first period of time during which the electric vehicle is operational; receive second motoring battery information for a second motoring battery of a second electric vehicle, the second motoring battery information indicating discharge of the second motoring battery over a second period of time during which the second electric vehicle is operational, the second electric vehicle travelling with the electric vehicle in a group of electric vehicles; and display a graphical interface on the display, the graphical interface presenting the first motoring battery information and the second motoring battery information in real-time.

The electric vehicle described above may include any of the following features, in any combinations.

In some embodiments, the instructions are configured to cause the one or more data processors to display the graphical interface on the display associated with the electric vehicle by plotting, on the display, a first curve illustrating the discharge of the first motoring battery and by plotting, on the display, a second curve illustrating the discharge of the second motoring battery.

In some embodiments, the instructions are configured to cause the one or more data processors to display the graphical interface on the display associated with the electric vehicle by displaying the first motoring battery information and the second motoring battery information on a display of the electric vehicle.

In some embodiments, the instructions are configured to cause the one or more data processors to display the graphical interface on the display associated with the electric vehicle by displaying the first motoring battery information and the second motoring battery information on a personal electronic device of an operator of the electric vehicle.

In some embodiments, the instructions are further configured to cause the one or more data processors to transmit the first motoring battery information to the group of electric vehicles.

In some embodiments, the instructions are configured to cause the one or more data processors to transmit the first motoring battery information to the group of electric vehicles by transmitting the first motoring battery information through a server remote from the group of electric vehicles.

In some embodiments, the instructions are configured to cause the one or more data processors to transmit the first motoring battery information to the group of electric vehicles by transmitting the first motoring battery information to the group of electric vehicles through a wireless connection defined between the electric vehicles of the group of electric vehicles.

In some embodiments, the first period of time at least partially overlaps with the second period of time.

In some embodiments, the instructions are further configured to cause the one or more data processors to: determine third motoring battery information indicating discharge of the first motoring battery over a third period of time during which the electric vehicle is operational, the third period of time occurring after the first period of time; receive at least one further wireless communication including fourth motoring battery information for the second motoring battery indicating discharge of the second motoring battery over a fourth period of time, the fourth period of time occurring after the second period of time; and display an updated graphical interface on the display associated with the electric vehicle, the updated graphical interface instantaneously presenting the first motoring battery information, the second motoring battery information, the third motoring battery information, and the fourth motoring battery information.

In some embodiments, the first motoring battery has a first battery capacity and the second motoring battery has a second battery capacity different from the first battery capacity; and the first motoring battery information is based on the first battery capacity and the second motoring battery information is based on the second battery capacity.

In some embodiments, the instructions are further configured to cause the one or more data processors to receive, from an operator interface of the electric vehicle, a request to join the group of electric vehicles.

In some embodiments, the request to join the group of electric vehicles comprises an identifier of the group.

In some embodiments, the request to join the group of electric vehicles comprises an identifier of another electric vehicle in the group.

In some embodiments, the first motoring battery information includes one or more of a first current state of charge (SoC) of the first motoring battery and a first remaining range available with the electric vehicle at the first current SoC, the second motoring battery information includes one or more of a second current state of charge (SoC) of the second motoring battery and a second remaining range available with the second electric vehicle at the second current SoC.

In some embodiments, the instructions are further configured to cause the one or more data processors to one or more of: alert the operator when the first current SoC differs from the second SoC by a SoC difference greater than a first threshold, and alert the operator when the first remaining range differs from the second remaining range by a range difference greater than a second threshold.

In some embodiments, the instructions are configured to cause the one or more data processors to alert the operator by proposing to the operator to switch a driving mode of the electric vehicle from a current driving mode to an extended range driving mode.

In some embodiments, the first motoring battery information includes a first current state of charge (SoC) of the electric vehicle, the instructions being further configured to cause the one or more data processors to compute the first remaining range of the electric vehicle as a function of the first current SoC and a first distance travelled by the electric vehicle during a trip with the group.

In some embodiments, the second motoring battery information includes a second current state of charge (SoC) of the second electric vehicle, the instructions being further configured to cause the one or more data processors to receive a second distance travelled by the second electric vehicle, and to compute the second remaining range of the second electric vehicle as a function of the second distance and the second current SoC during a trip with the group.

In yet another aspect, there is provided a method of facilitating an operation of a group of electric vehicles, the method comprising: receiving first motoring battery information indicating discharge of a first motoring battery over a first period of time, the first motoring battery associated with a first electric vehicle of the group of electric vehicles which is operational during the first period of time; and transmitting the first motoring battery information to a second electric vehicle of the group of electric vehicles, the first motoring battery information to be displayed on a display associated with the second electric vehicle in real-time.

The method described above may include any of the following features, in any combinations.

In some embodiments, the method includes receiving second motoring battery information indicating discharge of a second motoring battery over a second period of time, the second motoring battery associated with the second electric vehicle which is operational during the second period of time; and transmitting the second motoring battery information to first electric vehicle, the second motoring battery information to be displayed on a further display associated with the first electric vehicle in real-time.

In some embodiments, the method includes receiving third motoring battery information indicating discharge of a third motoring battery over a third period of time, the third motoring battery associated with a third electric vehicle of the group of electric vehicles which is operational during the third period of time; and transmitting the third motoring battery information to the second electric vehicle, the third motoring battery information to be instantaneously displayed with the first motoring battery information on the display associated with the second electric vehicle in real-time.

In some embodiments, the first period of time at least partially overlaps the second period of time.

In some embodiments, the first period of time at least partially overlaps the third period of time.

In some embodiments, the receiving of the first motoring battery information includes receiving a first current state of charge (SoC) of the first motoring battery and a first distance travelled by the first electric vehicle during the first period of time.

In some embodiments, the method includes computing a first remaining range available with the first electric vehicle at the first current SoC as a function of the first current SoC and the first distance.

In some embodiments, the method includes transmitting the first remaining range to the second electric vehicle.

In some embodiments, the receiving of the second motoring battery information includes receiving a second current state of charge (SoC) of the second motoring battery and a second distance travelled by the second electric vehicle during the second period of time.

In some embodiments, the method includes computing a second remaining range available with the second electric vehicle at the second current SoC as a function of the second current SoC and the second distance.

In some embodiments, the method includes transmitting the second remaining range to the first electric vehicle.

In some embodiments, the receiving of the third motoring battery information includes receiving a third current state of charge (SoC) of the third motoring battery and a first distance travelled by the third electric vehicle during the third period of time.

In some embodiments, the method includes computing a third remaining range available with the third electric vehicle at the third current SoC as a function of the third current SoC and third first distance.

In some embodiments, the method includes transmitting the third remaining range to the second electric vehicle.

In still another aspect, there is provided a server operatively connected to a group of electric vehicles, comprising: one or more data processors; and a non-transitory machine-readable memory storing instructions executable by the one or more data processors and configured to cause the one or more data processors to: receive first motoring battery information indicating discharge of a first motoring battery over a first period of time, the first motoring battery associated with a first electric vehicle of the group of electric vehicles which is operational during the first period of time; and transmit the first motoring battery information to a second electric vehicle of the group of electric vehicles, the first motoring battery information to be displayed on a display associated with the second electric vehicle in real-time.

The server described above may include any of the following features, in any combinations.

In some embodiments, the instructions are further configured to cause the one or more data processors to: receive second motoring battery information indicating discharge of a second motoring battery over a second period of time, the second motoring battery associated with the second electric vehicle which is operational during the second period of time; and transmit the second motoring battery information to first electric vehicle, the second motoring battery information to be displayed on a further display associated with the first electric vehicle in real-time.

In some embodiments, the instructions are further configured to cause the one or more data processors to: receive third motoring battery information indicating discharge of a third motoring battery over a third period of time, the third motoring battery associated with a third electric vehicle of the group of electric vehicles which is operational during the third period of time; and transmit the third motoring battery information to the second electric vehicle, the third motoring battery information to be instantaneously displayed with the first motoring batter information on the display associated with the second electric vehicle in real-time.

In some embodiments, the first period of time at least partially overlaps the second period of time.

In some embodiments, the first period of time at least partially overlaps the third period of time.

In some embodiments, the instructions are further configured to cause the one or more data processors to receive of the first motoring battery information by receiving a first current state of charge (SoC) of the first motoring battery and a first distance travelled by the first electric vehicle during the first period of time.

In some embodiments, the instructions are further configured to cause the one or more data processors to compute a first remaining range available with the first electric vehicle at the first current SoC as a function of the first current SoC and the first distance.

In some embodiments, the instructions are further configured to cause the one or more data processors to transmit the first remaining range to the second electric vehicle.

In some embodiments, the instructions are further configured to cause the one or more data processors to receive the second motoring battery information by receiving a second current state of charge (SoC) of the second motoring battery and a second distance travelled by the second electric vehicle during the second period of time.

In some embodiments, the instructions are further configured to cause the one or more data processors to compute a second remaining range available with the second electric vehicle at the second current SoC as a function of the second current SoC and the second distance.

In some embodiments, the instructions are further configured to cause the one or more data processors to transmit the second remaining range to the first electric vehicle.

In some embodiments, the instructions are further configured to cause the one or more data processors to receive of the third motoring battery information by receiving a third current state of charge (SoC) of the third motoring battery and a first distance travelled by the third electric vehicle during the third period of time.

In some embodiments, the instructions are further configured to cause the one or more data processors to compute a third remaining range available with the third electric vehicle at the third current SoC as a function of the third current SoC and third first distance.

In some embodiments, the instructions are further configured to cause the one or more data processors to transmit the third remaining range to the second electric vehicle.

### BRIEF DESCRIPTION OF THE DRAWINGS

Reference is now made to the accompanying figures in which:

FIG. 1A is a schematic three dimensional view of a personal watercraft in accordance with one embodiment;

FIG. 1B is a schematic cross-sectional view of the personal watercraft of FIG. 1A;

FIG. 2A is a schematic side view of a snowmobile in accordance with one embodiment;

FIG. 2B is another schematic side view of the snowmobile of FIG. 2A with parts removed for illustration purposes; and

FIG. 2C is a schematic three dimensional view illustrating a powertrain of the snowmobile of FIG. 2A;

FIG. 3A is a schematic representation of an electric vehicle in accordance with one embodiment;

FIG. 3B is a schematic representation of a battery management system of a motoring battery of the electric vehicle of FIG. 3A;

FIG. 4 is a schematic representation of a group of electric vehicles operatively connected to a server in accordance with one embodiment;

FIG. 5 is a flowchart illustrating steps of a method of facilitating operation of the electric vehicle of FIG. 3A;

FIG. 6A is a schematic representation of a display associated with the electric vehicle of FIG. 3A;

FIG. 6B is a schematic representation of another display associated with the electric vehicle of FIG. 3A;

FIG. 7 is a schematic representation of a request message to be displayed by a display associated with the electric vehicle of FIG. 3A;

FIG. 8 is a schematic representation of an alert message to be displayed on the display associated with the electric vehicle of FIG. 3A; and

FIG. 9 is a flowchart illustrating steps of a method of facilitating operation of the electric vehicle of FIG. 3A to be implemented by the server of FIG. 4.

### DETAILED DESCRIPTION

### Introduction

The systems and methods described herein may be suitable for electric vehicles, including electric off-road vehicles and electric powersport vehicles. Non-limiting examples of electric off-road/powersport vehicles include snowmobiles, motorcycles, watercraft such as boats and personal watercraft (PWC), all-terrain vehicles (ATVs), and utility task vehicles (UTVs) (e.g., side-by-sides). Examples of an electric personal watercraft and an electric snowmobile that may implement the systems and methods described herein will now be provided.

### Electric Watercraft

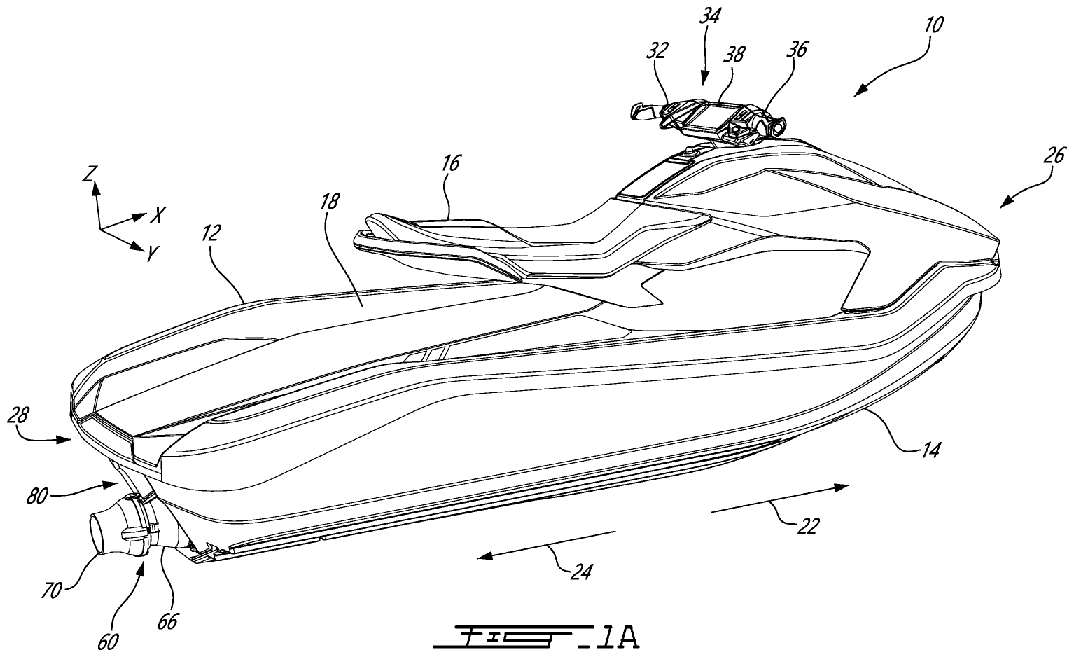

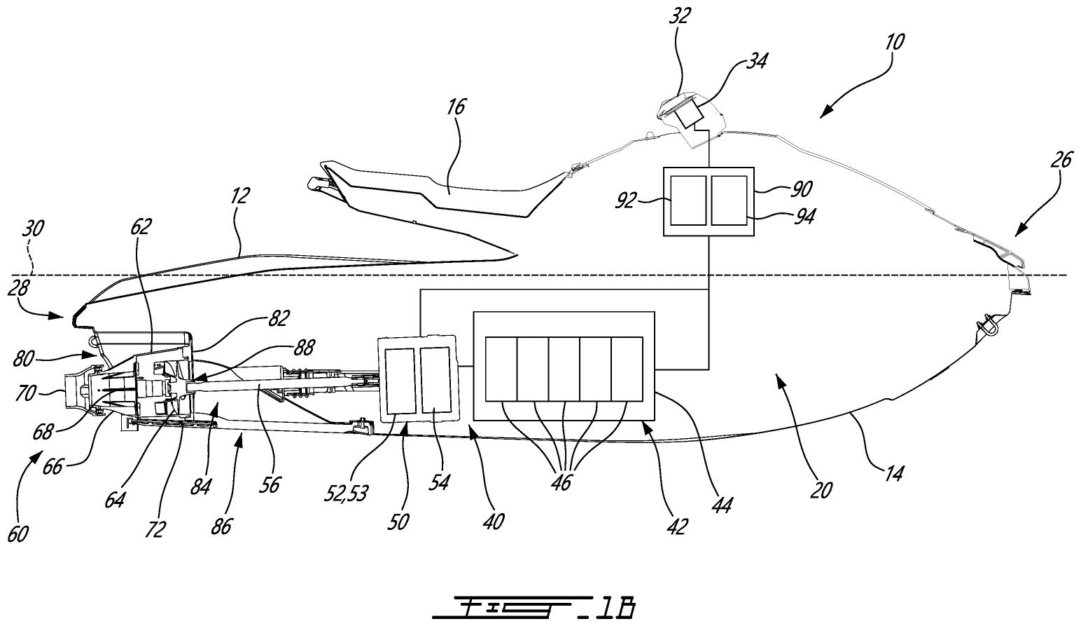

FIGS. 1A and 1B illustrate a perspective view and a longitudinal cross-sectional view of a watercraft 10, according to an embodiment. The watercraft 10 may be utilized for transporting one or more riders (e.g., an operator and optionally one or more passengers) over a body of water. The watercraft 10 may also be referred to as a “personal watercraft 10” or “PWC 10”. An upper portion of the watercraft 10 is formed of a deck 12 and a lower portion of the watercraft 10 is formed of a hull 14, which sits in the water. A straddle seat 16 is secured to the deck 12 and sized for accommodating the riders of the watercraft 10. The deck 12 defines foot wells 18 on either side of the straddle seat 16. A steering mechanism 32 (e.g., a set of handlebars) is coupled to the deck 12 forward of the straddle seat 16. The steering mechanism 32 are rotatable by an operator of the watercraft 10 to steer the watercraft 10. The hull 14 and the deck 12 may be coupled together along a seam using adhesives and/or fasteners. When coupled together, the hull 14 and the deck 12 enclose an interior volume 20 of the watercraft 10 which provides buoyancy to the watercraft 10 and houses at least some components thereof.

The watercraft 10 may move along a forward direction of travel 22 and a rear or aft direction of travel 24 (shown in FIG. 1A). The forward direction of travel 22 is the direction along which the watercraft 10 travels in most instances when displacing. The aft direction of travel 24 is the direction along which the watercraft 10 displaces occasionally, such as when reversing. The watercraft 10 includes a bow 26 and a stern 28 defined with respect to the forward direction of travel 22 and the aft direction of travel 24, such that the bow 26 is positioned ahead of the stern 28 relative to the forward direction of travel 22, and that the stern 28 is positioned astern of the bow 26 relative to the aft direction of travel 24. The watercraft 10 defines a longitudinal center axis 30 (shown in FIG. 1B) that extends between the bow 26 and the stern 28. A port side and a starboard side of the watercraft 10 are defined on opposite lateral sides of the longitudinal center axis 30. The positional descriptors “front”, “aft”, “rear” and terms related thereto are used in the present disclosure to describe the relative position of components of the watercraft 10. For example, if a first component of the watercraft 10 is described herein as being in front of, or forward of, a second component, then the first component is closer to the bow 26 than the second component. Similarly, if a first component of the watercraft 10 is described herein as being aft of, or rearward of, a second component, then the first component is closer to the stern 28 than the second component. The watercraft 10 also includes a three-axes frame of reference that is displaceable with the watercraft 10, where the Z-axis is parallel to the vertical direction and defines heave and yaw (via rotation about the Z-axis) of the watercraft 10, the X-axis is parallel to the longitudinal center axis 30 and defines surge and roll (via rotation about the X-axis) of the watercraft 10, and the Y-axis is perpendicular to both the X and Z-axes (extending laterally between the starboard and port sides) and defines sway and pitch (via rotation about the Y-axis) of the watercraft 10.

Referring to FIG. 1B, the watercraft 10 is electrically propelled by an electric powertrain 40. The electric powertrain 40 includes an electric battery 42 (also referred to as a “battery pack”), and an electric motor 50. The powertrain 40 is operatively connected to a drive shaft 56 and a jet propulsion system 60. The electric battery 42, motor 50 and drive shaft 56 may be located, in whole or in part, within the interior volume 20 of the watercraft 10. The interior volume 20 may also include other components suitable for use with the watercraft 10 such as storage compartments, a thermal management system, floatation foam and/or a charger, for example. In other embodiments, the watercraft 10 may also or instead be propelled by a powertrain including an internal combustion engine. For example, the motor 50 may also or instead be an internal combustion engine.

The battery 42 includes a battery enclosure 44 housing one or more battery modules 46. In the illustrated example, the battery modules 46 are arranged in a row and/or stacked within the battery enclosure 44. The battery enclosure 44 may support the battery modules 46 and protect the battery modules 46 from external impacts, water and/or other hazards or debris. Each battery module 46 may contain one or more battery cells, such as pouch cells, cylindrical cells and/or prismatic cells, for example. In some implementations, the battery cells are rechargeable lithium-ion battery cells. The battery 42 may also include other components to help facilitate and/or improve the operation of the battery 42, including temperature sensors to monitor the temperature of the battery cells, voltage sensors to measure the voltage of one or more battery cells, current sensors to implement column counting to infer the state of charge (SOC) of the battery 42, and/or thermal channels that circulate a thermal fluid to control the temperature of the battery cells, for example. In some implementations, the battery 42 may output electric power at a voltage between 300 and 800 volts, for example. The watercraft 10 may also include a charger (not shown) to convert alternating current (AC) power from an external power source to direct current (DC) power to charge the battery 42. The charger may include, or be connected to, a charging port positioned forward of the straddle seat 16 to connect to a charging cable from an external power source. In some implementations, the charging port is covered by one or more protective flaps (e.g., made of plastic and/or rubber) to protect the charging port from water and other debris.

It should be noted that the battery 42 illustrated in FIG. 1B is shown by way of example. Other shapes, sizes and configurations of the battery 42 are contemplated. For example, while the battery 42 is shown forward of the motor 50 and driveshaft 56 in FIG. 1B, this need not always be the case. At least a portion of the battery 42 may also, or instead, extend overtop of the motor 50 and/or the driveshaft 56. Further, at least a portion of the battery 42 may be positioned on the port and starboard sides of the motor 50 and/or the driveshaft 56. In some implementations, the battery 42 may include multiple batteries that are interconnected via electrical cables, and housed in one or more battery enclosures 44.

The motor 50 may convert the electric power output from the battery 42 into motive power to drive the jet propulsion system 60 of the watercraft 10. In the illustrated embodiment, the motor 50 is a permanent magnet synchronous motor having a rotor 52 and stator 53. The motor 50 also includes a power electronics module 54 (sometimes referred to as an inverter) to convert the DC power from the battery 42 to AC power having a desired voltage, current and waveform to drive the motor 50. In some implementations, the power electronics module 54 may include one or more capacitors to reduce the voltage variations between the high and low DC voltage leads, and one or more electric switches (e.g., insulated-gate bipolar transistors (IGBTs)) to generate the AC power. In some implementations, the motor 50 has a maximum output power of between 90 KW and 135 KW, for example. In other implementations, the motor 50 has a maximum output power greater than 135 kW.

In some implementations, the motor 50 may include sensors configured to sense one or more parameters of the motor 50. The sensors may be implemented in the rotor 52, the stator 53 and/or the power electronics module 54. The sensors may include a position sensor (e.g., an encoder) to measure a position and/or rotational speed of the rotor 52, and/or a speed sensor (e.g., a revolution counter) to measure the rotational speed of the rotor 52. Alternatively or additionally, the sensors may include a torque sensor to measure an output torque from the motor 50 and/or a current sensor (e.g., a Hall effect sensor) to measure an output current from the power electronics module 54.

Other embodiments of the motor 50 are also contemplated. For example, the power electronics module 54 may be integrated into the housing or casing of motor 50, as shown in FIG. 1B. However, the power electronics module 54 may also, or instead, be provided externally to the housing or casing of the motor 50. In some embodiments, the motor 50 may be a type other than a permanent magnet synchronous motor. For example, the motor 50 may instead be a brushless direct current motor.

The jet propulsion system 60 (also referred to as a “jet pump”) of the watercraft 10 creates a pressurized jet of water which provides thrust to propel the watercraft 10 through the water. A tunnel 80 formed at the stern 28 of the hull 14 at least partially accommodates the jet propulsion system 60. The jet propulsion system 60 includes a housing 62, which is a hollow body that delimits an interior channel or duct of the jet propulsion system 60. The housing 62 is coupled to the hull 14 at a rear wall 82 formed at a front end of the tunnel 80. The hull 14 also at least partially defines a water intake duct 84 having an inlet 86 provided at an underside of the hull 14 and an outlet 88 at the rear wall 82 to provide water to the jet propulsion system 60. In some implementations, a grate may be disposed over the inlet 86 to inhibit the intake of debris into the jet propulsion system 60.

The jet propulsion system 60 includes an impeller 64 positioned within the housing 62 to draw water through the intake duct 84. An inner wall of the housing 62 that surrounds the impeller 64 (referred to as a “wear ring”) may be a component that experiences wear and may be replaced. The impeller 64 is coupled to the motor 50 via the driveshaft 56. The driveshaft 56 extends through the hull 14, the intake duct 84 and the outlet 88 to couple to the impeller 64. The drive shaft 56 transfers motive power from the motor 50 to the impeller 64. The motor 50 is therefore drivingly engaged to the impeller 64. In the illustrated embodiment, the motor 50 is in a direct-drive arrangement with the impeller 64, such that a connection between the motor 50 and the impeller 64 is free of a gearbox. In other embodiments, a transmission may be used to provide a speed ratio between the motor 50 and the impeller 64.

Water ejected from the impeller 64 is directed through a venturi 66 (also referred to as a “nozzle”) formed by the housing 62 that further accelerates the water to provide additional thrust. The venturi 66 includes inwardly extending stator vanes 68 to convert the rotational flow of the water exiting the impeller 64 to thrust. The accelerated water jet is ejected from the venturi 66 via a pivoting steering nozzle 70 to provide a directionally controlled jet of water. The steering mechanism 32 may be mechanically coupled to the steering nozzle 70 to allow an operator to pivot the steering nozzle 70 and steer the watercraft 10. Pivoting the steering nozzle 70 horizontally to direct the water jet towards the port or starboard side of the watercraft 10 may turn the watercraft 10 to either side. The steering nozzle 70 may also pivot vertically to control the trim of the steering nozzle 70, thereby adjusting the running angle of the watercraft 10 in the water. Trimming the steering nozzle 70 upward helps to push the bow 26 of the watercraft 10 upward and may allow for the watercraft 10 to travel faster. Conversely, trimming the steering nozzle 70 downward helps to push the bow 26 of the watercraft 10 into the water which may allow for better navigation of the watercraft 10.

The watercraft 10 further includes a ride plate 72 that is coupled to the hull 14 below the jet propulsion system 60. The ride plate 72 may partially define the intake duct 84 and include a bottom surface that contributes to the ride and handling characteristics of the watercraft 10 in the water. In some implementations, the ride plate 72 may also include a heat exchanger forming part of a thermal management system of the watercraft 10. The heat exchanger may be a closed-loop heat exchanger having channels formed therein to carry a thermal fluid. The thermal fluid in the heat exchanger may be cooled by the water flowing past the ride plate 72, and then be pumped through thermal channels in the battery 42 and the motor 50, for example, to regulate the heat of those components during use. In some embodiments, the thermal management system may also include a heater (not shown) to heat the thermal fluid to provide heating to one or both of the battery 42 and the motor 50.

One or more controllers 90 (referred to hereinafter in the singular) and an instrument panel 34 are part of a control system for controlling operation of the watercraft 10. The instrument panel 34 allows an operator of the watercraft 10 to generate user inputs or instructions for the watercraft 10. The controller 90 is connected to the instrument panel 34 to receive the instructions therefrom and perform operations to implement those instructions. In the illustrated embodiment, the instrument panel 34 is provided on the steering mechanism 32 and the controller 90 is disposed within the interior volume 20, but this need not always be the case.

The instrument panel 34 includes an accelerator 36 (also referred to as a “throttle”) to allow an operator to control the thrust generated by the drivetrain 40. For example, the accelerator 36 may include a lever to allow the operator to selectively generate an accelerator signal. The controller 90 is operatively connected to the accelerator 36 and to the motor 50 to receive the accelerator signal and produce a corresponding output from the motor 50. In some implementations, the accelerator signal is mapped to a rotational speed (e.g., revolutions per minute (RPM)) of the motor 50. When the controller 90 receives an accelerator signal from the accelerator 36, the controller 90 may map the accelerator signal to a rotational speed of the motor 50 and control the power electronics module 54 to produce that rotational speed using feedback from sensors in the motor 50. The mapping of the accelerator signal to an output from the motor 50 may be based on a performance mode of the watercraft 10 (e.g., whether the watercraft 10 is in a power-saving mode, a normal mode or a high-performance mode). In some examples, the mapping of the accelerator signal to an output from the motor 50 may be based on current operating conditions of the powertrain 40 (e.g., a temperature of the battery 42 and/or motor 50, a SOC of the battery 42, etc.). In still other examples, the mapping of the accelerator signal to an output from the motor 50 may be user configurable, such that a user may customize an accelerator position to motor output mapping.

The watercraft 10 may be capable of generating reverse thrust to slow down the watercraft 10 when traveling in the forward direction of travel 22 and/or to propel the watercraft 10 in the reverse direction of travel 24. The instrument panel 34 may include a distinct user input device (e.g., a brake lever and/or reverse button) to instruct the controller 90 to generate reverse thrust. In some implementations, reverse thrust is generated by reversing the direction of the motor 50, which draws water in from the steering nozzle 70 and expels the water out from the inlet 86 of the intake duct 84. Alternatively, reverse thrust may be generated using a reverse bucket or deflector gate that deflects the water jet from the venturi 66 forwards, thereby generating reverse thrust.

In addition to the accelerator 36, the instrument panel 34 may include other user input devices (e.g., levers, buttons and/or switches) to control various other functionality of the watercraft 10. These user input devices may be connected to the controller 90, which executes the instructions received from the user input devices. Non-limiting examples of such user input devices include a device to switch the watercraft 10 between different vehicle states (e.g., “off”, “neutral” and “drive” states), a device to switch the watercraft 10 between different performance modes, and a device to adjust the trim of the steering nozzle 70. The instrument panel 34 also includes a display screen 38 (shown in FIG. 1A) connected to the controller 90 that displays information pertaining to the watercraft 10 to an operator. Non-limiting examples of such information include the current state of the watercraft 10, the current performance mode of the watercraft 10, the speed of the watercraft 10, the SOC of the battery 42, the RPM of the motor 50, and the power output from the motor 50. The display screen 38 may include a liquid crystal display (LCD) screen, thin-film-transistor (TFT) LCD screen, light-emitting diode (LED) or other suitable display device. In some embodiments, display screen 38 may be touch-sensitive to facilitate operator inputs.

The controller 90 may also control additional functionality of the watercraft 10. For example, the controller 90 may control a battery management system (BMS) to monitor the SOC of the battery 42 and manage charging and discharging of the battery 42. In another example, the controller 90 may control a thermal management system to manage a temperature of the battery 42 and/or the motor 50 using a thermal fluid cooled by a heat exchanger in the ride plate 72. Temperature sensors in the battery 42 and/or the motor 50 may be connected to the controller 90 to monitor the temperature of these components.

The controller 90 includes one or more data processors 92 (referred hereinafter as “processor 92”) and non-transitory machine-readable memory 94. The memory 94 may store machine-readable instructions which, when executed by the processor 92, cause the processor 92 to perform any computer-implemented method or process described herein. The processor 92 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 94 may include any suitable machine-readable storage medium such as, for example, an electronic, magnetic, optical, electromagnetic, infrared, or semiconductor system, apparatus, or device, or any suitable combination thereof. The memory 94 may be located internally and/or externally to the controller 90.

Although the controller 90 is shown as a single component in FIG. 1B, this is only an example. In some implementations, the controller 90 may include multiple controllers distributed at various locations in the watercraft 10. For example, the controller 90 may include a vehicle control unit (also referred to as a “body controller”) that is responsible for interpreting the inputs from various other controllers in the watercraft 10. Non-limiting examples of these other controllers include a motor controller that is part of the power electronics module 54 and a battery management controller that is part of the battery 42. Optionally, separate battery management controllers may be implemented in the each of the battery modules 160 to form a distributed battery management system.

Systems and methods are described and shown in the present disclosure in relation to the watercraft 10, but the present disclosure may also be applied to other types of vehicles, including other types of off-road and powersport vehicles.

### Electric Snowmobile

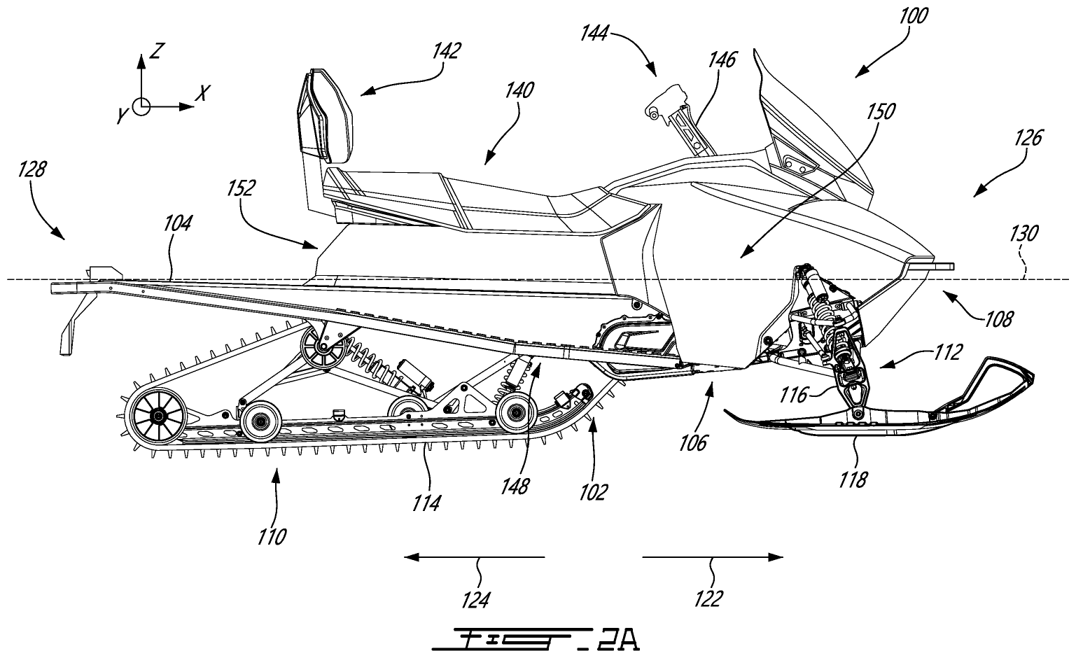

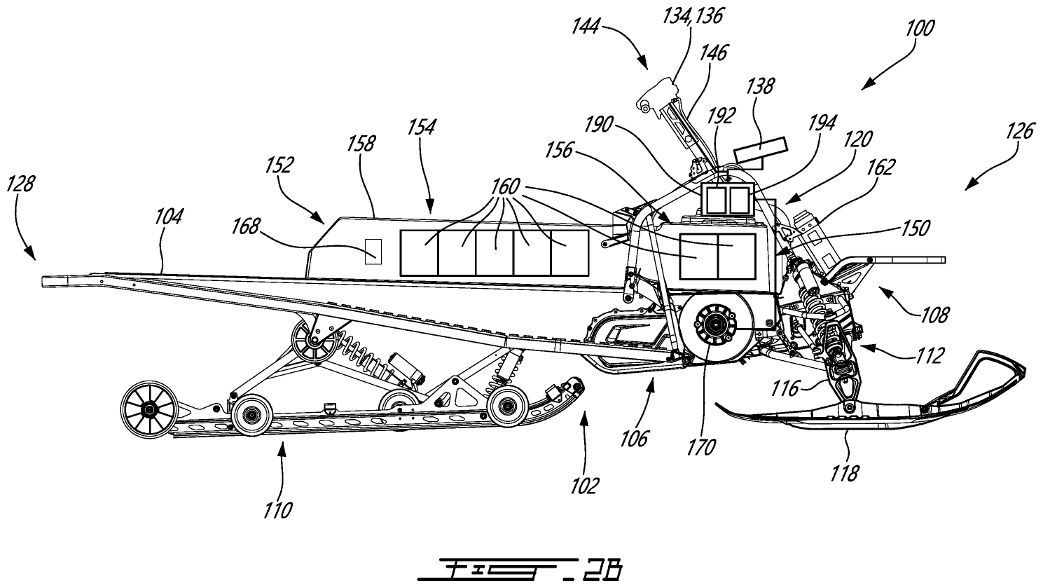

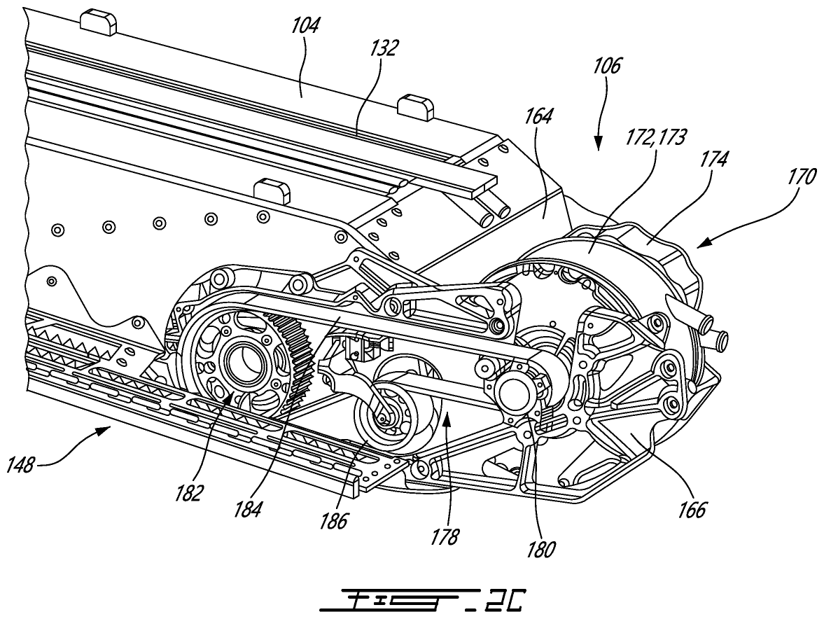

FIG. 2A illustrates a side plan view of a snowmobile 100, according to an embodiment, and FIG. 2B illustrates another side plan view of the snowmobile 100 with several body panels and other components removed so that the interior of the snowmobile 100 may be viewed. The snowmobile 100 includes a frame 102, which may also be referred to as a “chassis” or “body”, that provides a load bearing framework for the snowmobile 100. In the illustrated embodiment, the frame 102 includes a longitudinal tunnel, referred to below simply as a tunnel 104, a mid-bay 106 (or “bulkhead”) coupled forward of the tunnel 104, and a front sub-frame 108 (or “front brace”) coupled forward of the mid-bay 106. In some implementations, the mid-bay 106 may form part of the front sub-frame 108.

The snowmobile 100 also includes a rear suspension assembly 110 and a front suspension assembly 112 to provide shock absorption and improve ride quality. The rear suspension assembly 110 may be coupled to the underside of the tunnel 104 to facilitate the transfer of loads between the rear suspension assembly 110 and the tunnel 104. The rear suspension assembly 110 supports a drive track 114 having the form of an endless belt for engaging the ground (e.g., snow) and propelling the snowmobile 100. The rear suspension assembly may include, inter alia, one or more rails and/or idler wheels for engaging with the drive track 114, and one or more control arms and damping elements (e.g., elastic elements such as coil and/or torsion springs forming a shock absorber) connecting the rails to the tunnel 104. The front suspension assembly 112 includes two suspension legs 116 coupled to the front sub-frame 108 and to respective ground engaging front skis 118 (only one suspension leg 116 and ski 118 are visible in FIGS. 1A and 1B). Each of the suspension legs 116 may include two A-frame arms connected to the front sub-frame 108, a damping element (e.g., an elastic element) connected to the front sub-frame 108, and a spindle connecting the A-frame arms and the damping element to a respective one of the skis 118. The suspension legs 116 transfer loads between the skis 118 and the front sub-frame 108. In the illustrated embodiment, the frame 102 also includes an over structure 120 (shown in FIG. 1B), that may include multiple members (e.g., tubular members) interconnecting the tunnel 104, the mid-bay 106 and/or the front sub-frame 108 to provide additional rigidity to the frame 102. However, as discussed elsewhere herein, the over structure 120 may be omitted in some embodiments.

The snowmobile 100 may move along a forward direction of travel 122 and a rearward direction of travel 124 (shown in FIG. 1A). The forward direction of travel 122 is the direction along which the snowmobile 100 travels in most instances when displacing. The rearward direction of travel 124 is the direction along which the snowmobile 100 displaces only occasionally, such as when it is reversing. The snowmobile 100 includes a front end 126 and a rear end 128 defined with respect to the forward direction of travel 122 and the rearward direction of travel 124. For example, the front end 126 is positioned ahead of the rear end 128 relative to the forward direction of travel 122. The snowmobile 100 defines a longitudinal center axis 130 that extends between the front end 126 and the rear end 128. Two opposing lateral sides of the snowmobile 100 are defined parallel to the center axis 130. The positional descriptors “front”, “rear” and terms related thereto are used in the present disclosure to describe the relative position of components of the snowmobile 100. For example, if a first component of the snowmobile 100 is described herein as being in front of, or forward of, a second component, then the first component is closer to the front end 126 than the second component. Similarly, if a first component of the snowmobile 100 is described herein as being behind, or rearward of, a second component, then the first component is closer to the rear end 128 than the second component. The snowmobile 100 also includes a three-axes frame of reference that is displaceable with the snowmobile 100, where the Z-axis is parallel to the vertical direction, the X-axis is parallel to the center axis 130, and the Y-axis is parallel to the lateral direction.

The snowmobile 100 is configured to carry one or more riders, including a driver (sometimes referred to as an “operator”) and optionally one or more passengers. In the illustrated example, the snowmobile 100 includes a straddle seat 140 to support the riders. Optionally, the straddle seat 140 includes a backrest 142. The operator of the snowmobile 100 may steer the snowmobile 100 using a steering mechanism 144 (e.g., handlebars), which are operatively connected to the skis 118 via a steering shaft 146 to control the direction of the skis 118. The tunnel 104 may also include or be coupled to footrests 148 (also referred to as “running boards”), namely left and right footrests each sized for receiving a foot of one or more riders sitting on the straddle seat 140.

Referring to FIG. 1B, the snowmobile 100 is electrically propelled by an electric powertrain 150. The powertrain 150 includes an electric battery 152 (also referred to as a “battery pack”) and an electric motor 170. The battery 152 is electrically connected to the motor 170 to provide electric power to the motor 170. The motor 170, in turn, is drivingly coupled to the drive track 114 to propel the snowmobile 100 across the ground. In other embodiments, the snowmobile 100 may also or instead be propelled by a powertrain including an internal combustion engine. For example, the motor 170 may also or instead be an internal combustion engine.

The battery 152 may include a battery enclosure 158 that houses one or more battery modules 160. The battery enclosure 158 may support the battery modules 160 and protect the battery modules 160 from external impacts, water and/or other hazards or debris. Each battery module 160 may contain one or more battery cells, such as pouch cells, cylindrical cells and/or prismatic cells, for example. In some implementations, the battery cells are rechargeable lithium-ion battery cells. The battery 152 may also include other components to help facilitate and/or improve the operation of the battery 152, including temperature sensors to monitor the temperature of the battery cells, voltage sensors to measure the voltage of one or more battery cells, current sensors to implement column counting to infer the state of charge (SOC) of the battery 42, and/or thermal channels that circulate a thermal fluid to control the temperature of the battery cells. In some implementations, the battery 152 may output electric power at a voltage of between 300 and 800 volts, for example. The snowmobile 100 may also include a charger 162 to convert AC to DC current from an external power source to charge the battery 152. The charger 162 may include, or be connected to, a charging port positioned forward of the straddle seat 140 to connect to a charging cable from an external power source. In some implementations, the charging port is covered by one or more protective flaps (e.g., made of plastic and/or rubber) to protect the charging port from water, snow and other debris.

In some implementations, the battery 152 may be generally divided into a tunnel battery portion 154 and a mid-bay battery portion 156. The tunnel battery portion 154 may be positioned above and coupled to the tunnel 104. As illustrated, the straddle seat 140 is positioned above the tunnel battery portion 154 and, optionally, the straddle seat 140 may be supported by the battery enclosure 158 and/or internal structures within the battery 152. The mid-bay battery portion 156 extends into the mid-bay 106 and may be coupled to the mid-bay 106 and/or to the front sub-frame 108. The tunnel battery portion 154 and the mid-bay battery portion 156 may share a single battery enclosure 158, or alternatively separate battery enclosures. In the illustrated example, the tunnel battery portion 154 and the mid-bay battery portion 156 each include multiple battery modules 160 that are arranged in a row and/or stacked within the battery enclosure 158.

It should be noted that other shapes, sizes and configurations of the battery 152 are contemplated. For example, the battery 152 may include multiple batteries that are interconnected via electrical cables. In some embodiments, the battery enclosure 158 may be a structural component of the snowmobile 100 and may form part of the frame 102. For example, the battery enclosure 158 may be coupled to the front sub-frame 108 to transfer loads between the front sub-frame 108 and the tunnel 104. The battery enclosure 158 may be formed from a fiber composite material (e.g., a carbon fiber composite) for additional rigidity. Optionally, in the case that the battery enclosure 158 is a structural component of the snowmobile 100, the over structure 120 may be omitted.

FIG. 2C is a perspective view of the mid-bay 106 of the snowmobile 100. As illustrated, the motor 170 is disposed in a lower portion of the mid-bay 106, below the mid-bay battery portion 156 and forward of a wall 164 defining a front end of the tunnel 104. The motor 170 may be mounted to a transmission plate 166 that is supported between the tunnel 104 and the front sub-frame 108 to help support the motor 170 within the mid-bay 106.

In the illustrated embodiment, the motor 170 is a permanent magnet synchronous motor having a rotor 172 and stator 173. The motor 170 also includes power electronics module 174 (sometimes referred to as an inverter) to convert the direct current (DC) power from the battery 152 to alternating current (AC) power having a desired voltage, current and waveform to drive the motor 170. In some implementations, the power electronics module 174 may include one or more capacitors to reduce the voltage variations between the high and low DC voltage leads, and one or more electric switches (e.g., insulated-gate bipolar transistors (IGBTs)) to generate the AC power. In some implementations, the motor 170 has a maximum output power of between 90 KW and 135 KW. In other implementations, the motor 170 has a maximum output power greater than 135 kW.

In some implementations, the motor 170 may include sensors configured to sense one or more parameters of the motor 170. The sensors may be implemented in the rotor 172, the stator 173 and/or the power electronics module 174. The sensors may include a position sensor (e.g., an encoder) to measure a position and/or rotational speed of the rotor 172, and/or a speed sensor (e.g., a revolution counter) to measure the rotational speed of the rotor 172. Alternatively or additionally, the sensors may include a torque sensor to measure an output torque from the motor 170 and/or a current sensor (e.g., a Hall effect sensor) to measure an output current from the power electronics module 174.

Other embodiments of the motor 170 are also contemplated. For example, the power electronics module 174 may be integrated into the housing or casing of motor 170, as shown in FIG. 2C. However, the power electronics module 174 may also, or instead, be provided externally to the housing or casing of motor 170. In some embodiments, the motor 170 may be a type other than a permanent magnet synchronous motor. For example, the motor 170 may instead be a brushless direct current motor.

The motor 170 may convert the electric power output from the battery 152 into motive power that is transferred to the drive track 114 via a drive transmission 178. The drive transmission 178 engages with a motor drive shaft 180 of the motor 170. The motor drive shaft 180 may extend laterally through an opening in the transmission plate 166. The drive transmission 178 includes a track drive shaft 182 that extends laterally across the tunnel 104. The motor drive shaft 180 and the track drive shaft 182 may extend parallel to each other along transverse axes of the snowmobile 100 and may be spaced apart from each other along the longitudinal axis 130. In the illustrated embodiment, the motor drive shaft 180 is operably coupled to the track drive shaft 182 via a drive belt 184. Sprockets on the motor drive shaft 180 and the track drive shaft 182 may engage with lugs on the drive belt 184. A drive belt idler pulley 186 may also be implemented to maintain tension on the drive belt 184. In other embodiments, another form of linkage such as a drive chain, for example, may operatively connect the motor drive shaft 180 and the track drive shaft 182.

In operation, torque from the motor 170 is transferred from the motor drive shaft 180 to the track drive shaft 182 via the drive belt 184. The track drive shaft 182 includes one or more sprockets (not shown) that engage with lugs on the drive track 114, thereby allowing the track drive shaft 182 to transfer motive power to the drive track 114. It will be understood that the motor 170 may be operated in two directions (i.e., rotate clockwise or counter-clockwise), allowing the snowmobile 100 to travel in the forward direction of travel 122 and in the rearward direction of travel 124. In some implementations, the drive track 114 and the snowmobile 100 may be slowed down via electrical braking (e.g., regenerative braking) implemented by the motor 170 and/or by a mechanical brake (e.g., a disc brake) connected to one of the track drive shaft 182 or the motor drive shaft 180.

The snowmobile 100 may include a heat exchanger 132 that is coupled to, or integrated with, the tunnel 104. The heat exchanger 132 may form part of a thermal management system to control the temperature of the battery 152, the motor 170 and the charger 162, for example. The heat exchanger may include channels to carry a thermal fluid along a portion of the tunnel 104. During operation of the snowmobile 100, the heat exchanger 132 may be exposed to snow and cold air circulating in the tunnel 104 that cools the thermal fluid. The thermal fluid may then be pumped through thermal channels in the battery 152, the motor 170 and/or the charger 162, for example, to cool those components. In some implementations, the thermal management system of the snowmobile 100 may also include a heater 168 (shown in FIG. 2B) to heat the thermal fluid and warm the battery 152. Warming the battery 152 may be useful if the snowmobile 100 has been left for an extended period in a cold environment. In such a case, the temperature of the battery cells in the battery modules 160 may fall to a level where high power is limited from being drawn from the battery 152. Warming the battery 152 may bring the battery cells back into an efficient operating regime. In some implementations, the heater 168 is disposed within the battery enclosure 158.

Referring again to FIG. 2B, one or more controllers 190 (referred to hereinafter in the singular) and an instrument panel 134 are part of a control system for controlling operation of the snowmobile 100. The instrument panel 134 allows an operator of the snowmobile 100 to generate user inputs and/or instructions for the snowmobile 100. The controller 190 is connected to the instrument panel 134 to receive the instructions therefrom and perform operations to implement those instructions. In the illustrated embodiment, the instrument panel 134 is provided on the steering mechanism 144 and the controller 190 is disposed within the interior of the snowmobile 100, but this need not always be the case.

The instrument panel 134 includes an accelerator 136 (also referred to as a “throttle”) to allow an operator to control the power generated by the powertrain 150. For example, the accelerator 136 may include a lever to allow the operator to selectively generate an accelerator signal. The controller 190 is operatively connected to the accelerator 136 and to the motor 170 to receive the accelerator signal and produce a corresponding output from the motor 170. In some implementations, the accelerator signal is mapped to a torque of the motor 170. When the controller 190 receives an accelerator signal from the accelerator 136, the controller 190 maps the accelerator signal to a torque of the motor 170 and controls the power electronics module 174 to produce that torque using feedback from sensors in the motor 50. The mapping of the accelerator signal to an output from the motor 170 may be based on a performance mode of the snowmobile 100 (e.g., whether the snowmobile 100 is in a power-saving mode, a normal mode or a high-performance mode). In some examples, the mapping of the accelerator signal to an output from the motor 170 may be based on current operating conditions of the powertrain 150 (e.g., temperature of the battery 152 and/or motor 170, state of charge of the battery 152, etc.). In still other examples, the mapping of the accelerator signal to an output from the motor 170 may be user configurable, such that a user may customize an accelerator position to motor output mapping.

In addition to the accelerator 136, the instrument panel 134 may include other user input devices (e.g., levers, buttons and/or switches) to control various other functionality of the snowmobile 100. These user input devices may be connected to the controller 190, which executes the instructions received from the user input devices. Non-limiting examples of such user input devices include a brake lever to implement mechanical and/or electrical braking of the snowmobile 100, a reverse option to propel the snowmobile 100 in the rearward direction of travel 124, a device to switch the snowmobile 100 between different vehicle states (e.g., “off”, “neutral” and “drive” states), a device to switch the snowmobile 100 between different performance modes, a device to switch between regenerative braking modes (e.g. “off”, “low” and “high” modes) and a device to activate heating of handgrips of the steering mechanism. The snowmobile 100 also includes a display screen 138 connected to the controller 190. The display screen 138 may be provided forward of the steering mechanism 144, or in any other suitable location depending on the design of the snowmobile 100. The display screen 138 displays information pertaining to the snowmobile 100 to an operator. Non-limiting examples of such information include the current state of the snowmobile 100, the current performance mode of the snowmobile 100, the speed of the snowmobile 100, the state of charge (SOC) of the battery 152, the angular speed of the motor 170, and the power output from the motor 170. The display screen 138 may include a liquid crystal display (LCD) screen, thin-film-transistor (TFT) LCD screen, light-emitting diode (LED) or other suitable display device. In some embodiments, display screen 138 may be touch-sensitive to facilitate operator inputs.

The controller 190 may also control additional functionality of the snowmobile 100. For example, the controller 190 may control a battery management system (BMS) to monitor the SOC of the battery 152 and manage charging and discharging of the battery 152. In another example, the controller 190 may control a thermal management system to manage a temperature of the battery 152, the motor 170 and/or the charger 162 using a thermal fluid cooled by the heat exchanger 132 and/or heated by the heater 168. Temperature sensors in the battery 152 and/or the motor 170 may be connected to the controller 190 to monitor the temperature of these components.

The controller 190 includes one or more data processors 192 (referred hereinafter as “processor 192”) and non-transitory machine-readable memory 194. The memory 194 may store machine-readable instructions which, when executed by the processor 192, cause the processor 192 to perform any computer-implemented method or process described herein. The processor 192 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 194 may include any suitable machine-readable storage medium such as, for example, an electronic, magnetic, optical, electromagnetic, infrared, or semiconductor system, apparatus, or device, or any suitable combination thereof. The memory 194 may be located internally and/or externally to the controller 190.

Although the controller 190 is shown as a single component in FIG. 1B, this is only an example. In some implementations, the controller 190 may include multiple controllers distributed at various locations in the snowmobile 100. For example, the controller 190 may include a vehicle control unit (also referred to as a “body controller”) that is responsible for interpreting the inputs from various other controllers in the snowmobile 100. Non-limiting examples of these other controllers include a motor controller that is part of the power electronics module 174 and a battery management controller that is part of the battery 152. Optionally, separate battery management controllers may be implemented in the each of the battery modules 160 to form a distributed battery management system.

### Communicating Motoring Battery Information

An aspect of the present disclosure relates to systems and methods for sharing motoring battery information among a group of electric vehicles. This motoring battery information may indicate, inter alia, battery discharge over a period of time for each electric vehicle in the group. In some embodiments, the motoring battery information may be wirelessly communicated between the electric vehicles in the group and may be presented to the respective operators of the electric vehicles. For example, the motoring battery information for the entire group may be shown on a display of each electric vehicle (e.g., using a graphical plot) to present the information instantaneously and in real-time. Using the motoring battery information, each operator in the group may view and compare the remaining state of charge (SoC) and/or range of the electric vehicles. Further, each operator may view and compare the variation in SoC and/or range over time.

Communicating motoring battery information may be particularly useful for a group of electric powersport vehicles, as these vehicles are often ridden together in a group and different riding behaviours may have a significant impact on battery consumption. A high rate of power consumption by one operator in the group might limit the length of the trip for the rest of the group. By way of example, the electric personal watercraft 10 may be ridden in a group of electric watercraft traveling together. Motoring battery information for each watercraft in the group, including the personal watercraft 10 itself, may be displayed on the display screen 38. Such information may allow an operator of the personal watercraft 10 to better understand when the group will need to stop and/or turn around to recharge (e.g., based on the temporal trends in SoC and/or range of the group), and may also or instead allow the operator to adjust their own driving habits to better match their battery consumption to that of the group. Similar comments apply to the electric snowmobile 100 being ridden in a group of electric snowmobiles.

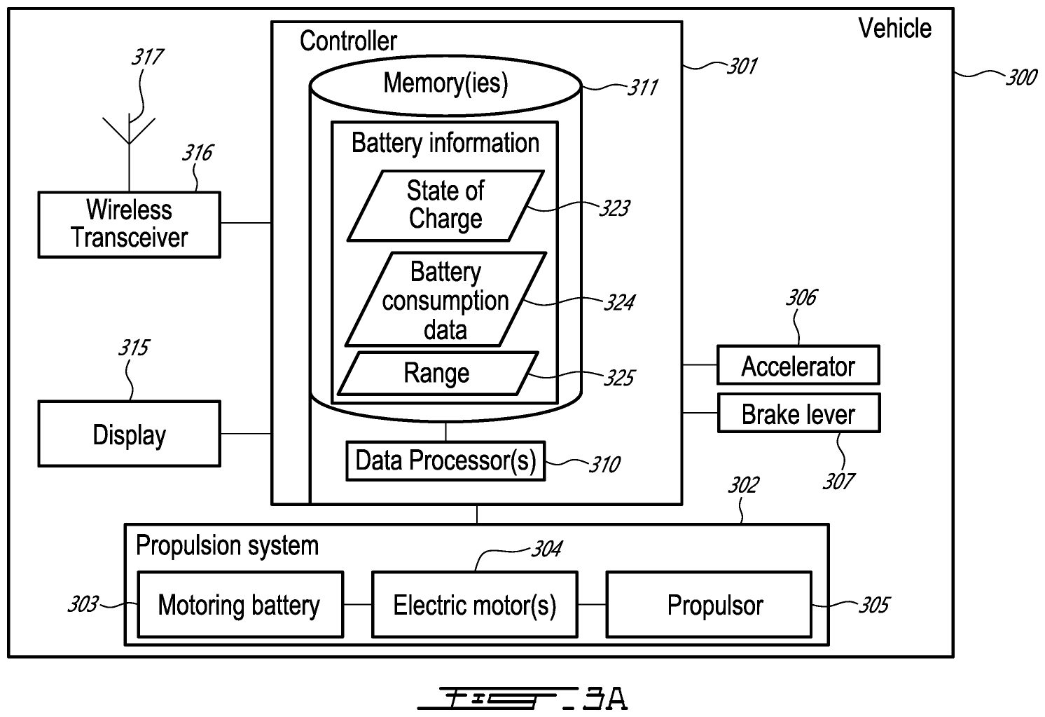

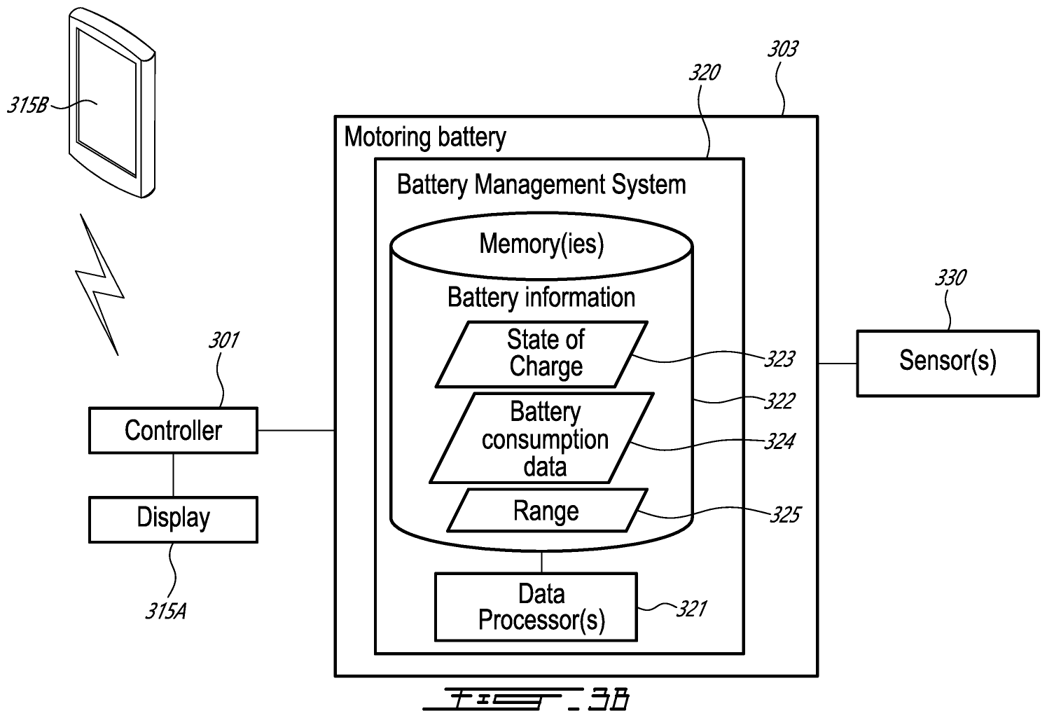

Referring now to FIG. 3A, shown is a schematic representation of an electric vehicle 300. The electric vehicle 300 may represent the personal watercraft 10 or the snowmobile 100, for example. The electric vehicle 300 includes a controller 301 (e.g., controller 90 for the personal watercraft, controller 190 for the snowmobile). The controller 301 is operatively connected to a propulsion system 302 that includes a motoring battery 303 operatively connected to one or more electric motor(s) 304 that is drivingly engaged to a propulsor 305 (e.g., jet propulsion system 60 for the personal watercraft 10, drive track 114 for the snowmobile 100, wheels for an all-terrain vehicle). The electric motor(s) 304 is therefore used to propel the electric vehicle 300.

The controller 301 is operatively connected to an accelerator 306 and to a brake lever 307. Signal(s) received from the accelerator 306 and to the brake lever 307 may be transmitted from the controller 301 to the propulsion system 302 for controlling operation of the electric vehicle 300. The brake lever 307 may also or instead be connected to a mechanical brake of the electric vehicle 300. The controller 301 includes one or more data processors 310 and one or more non-transitory machine-readable memory(ies) 311. The memory 311 may store machine-readable instructions which, when executed by the processor 310, cause the processor 310 to perform any computer-implemented method or process described herein. The processor 310 and memory 311 may correspond to the processor 92, 192 and memory 94, 194 described above. The controller 301 is operatively connected to a display 315 associated with the vehicle 300. Non-limiting examples of the display 315 are the display screen 38 and the display screen 138 described above. The controller 301 is further operatively connected to a wireless transceiver 316 that is itself operatively connected to an antenna 317. As will be described below, the wireless transceiver 316 and antenna 317 are used to exchange information with other electric vehicles 300 of a group of electric vehicles travelling together. In some implementations, the wireless transceiver 316 and antenna 317 exchange information using one or more standardized communication protocols such as Cellular (e.g., fifth generation (5G) or long term evolution (LTE) cellular communications), Bluetooth™, and/or WiFi™, for example. In some implementations, the wireless transceiver 316 and antenna 317 may also or instead exchange information using a communication protocol native to the group of electric vehicles (e.g., vehicle-to-vehicle radio communication). Different transceivers and/or antennas may be implemented to facilitate different communication protocols.

Referring to FIG. 3B, the motoring battery 303 includes a battery management system 320. The battery management system 320 may be itself seen as a controller for the battery 303 and includes one or more data processors 321 and one or more non-transitory machine-readable memory(ies) 322. The memory 322 may store machine-readable instructions which, when executed by the processor 321, cause the processor 321 to perform any computer-implemented method or process described herein. Although the battery management system 320 is depicted as being part of the battery, it may alternatively be implemented in whole or in part elsewhere in the electric vehicle 300 such as within the controller 301 of the electric vehicle 300, for example. In some implementations, the battery management system 320 may be a distributed system spread between multiple battery modules of the motoring battery 303.

The battery management system 320 of the motoring battery 303 of the electric vehicle 300 is used to manage the motoring battery 303, such as by protecting the battery from operating outside its safe operating area, monitoring its state, calculating battery data, reporting that data, controlling its environment, and so on. The battery management system 320 may be in communication with the controller 301 (FIG. 3A) of the electric vehicle 300 to transmit/receive one or more signal(s) to/from the controller 301. For example, the battery management system 320 may report battery data and/or a battery state to the controller 301 using a controller area network (CAN) bus.

One or more sensor(s) 330 may be used to measure various parameters relevant to the motoring battery 303. Data from the sensor(s) 330 may be provided to the battery management system 320 to, inter alia, determine a battery state and/or calculate battery data. Non-limiting examples of parameters that may be measured by the sensor(s) 330 include electrical voltages, temperatures, electrical current, and coolant flow. The voltages measured by the sensor(s) 330 may include a voltage of the motoring battery 303, voltages of individual battery modules in the motoring battery 303, and/or voltages of individual battery cells or groups of battery cells in the motoring battery 303. Similarly, the temperatures measured by the sensor(s) 330 may be representative of the temperature of the whole motoring battery 303, the temperatures of individual battery modules in the motoring battery 303, and/or the temperatures of individual battery cells or groups of battery cells in the motoring battery 303. Alternatively, or additionally, the temperatures measured by the sensor(s) 330 may include coolant temperatures at the inlet and/or outlet of a coolant manifold in the motoring battery 303. Electrical current may be measured into and/or out of the motoring battery 303, and/or in the electric motor(s) 304, for example.

Although the sensor(s) 330 are shown external to the motoring battery 303 in FIG. 3B, this is only an example. The sensor(s) 330 may also or instead be internal to the motoring battery 303. For example, temperature sensors may be implemented between battery cells in the motoring battery 303 and/or voltage measurements may be performed at the tabs of the battery cells.

In some embodiments, the battery management system 320 may determine motoring battery information regarding the motoring battery 303. This motoring battery information may include one or more sets of data pertaining to the state of the motoring battery over a period of time which, as discussed in further detail elsewhere herein, may be communicated to other electric vehicles. The motoring battery information may include, for instance, a state of charge (SoC) 323 of the motoring battery 303, battery consumption data 324 for the motoring battery 303, and/or a current range 325 of the electric vehicle 300 enabled by the motoring battery 303. In some embodiments, the motoring battery information may also, or instead, include other types of data pertaining to the motoring battery 303 such as the energy stored and/or consumed (e.g., in kWh), the charge stored and/or consumed (e.g., in Ah), a state of health (SoH), a state or power (SoP), a state of safety (SoS), and/or voltages, for example.

The SoC 323, the battery consumption data 324 and/or the range 325 may be computed by the battery management system 320 using data acquired via the sensor(s) 330. As noted above, the sensor(s) 330 may include one or more current sensors and/or one or more voltage sensors operatively connected to the battery 303 and may be configured to acquire one or more signals indicative of, or useful in deriving, an actual (e.g., current, live, real-time) SoC 323 of the battery 303. Any suitable methods for determining the SoC 323 may be used. For instance, in one embodiment, coulomb counting using the sensor(s) 330 to infer the SoC 323 of the battery 303 may be implemented. Coulomb counting may compare the amount of discharge from the motoring battery 303 to a known capacity of the motoring battery 303 to determine the SoC 323. The SoC 323 may be expressed as a percentage of the capacity of battery 303 (e.g., 0%=empty; 100%=full), or as any other suitable indication.

The sensor(s) 330 may be used to determine the battery consumption data 324 that may be indicative of a discharge rate (i.e., power utilization rate or cost) of battery 303 over time and/or over a distance travelled by electric vehicle 300. For example, the actual battery consumption data 324 may be expressed as a percentage of the capacity of battery 303 expended over time or distance (e.g., SoC (%)/hour; SoC (%)/km). Alternatively, the actual battery consumption data may be expressed as kilowatt-hours-per-kilometer or amp-hours-per-kilometer, for example. The distance travelled by the electric vehicle 300 and used in calculating the battery consumption data 324 may be determined based on satellite positioning data (e.g., global positioning system (GPS) data) and/or based on a speed of the electric motor(s) 304 integrated over time. Optionally, the sensor(s) 330 may include a GPS receiver to measure the GPS position of the electric vehicle 300.

In some implementations, the battery consumption data 324 may relate to a single trip of the electric vehicle 300 (e.g., using data collected since the last start-up of the electric vehicle 300), which may represent the efficiency of the electric vehicle 300 in its current operating conditions (e.g., the type of terrain being traversed and/or the weight carried by the electric vehicle 300). In some implementations, the battery consumption data 324 may relate to multiple trips by the electric vehicle 300, which may represent the average efficiency of the electric vehicle 300 in a variety of operating conditions.

The SoC 323, the battery consumption data 324, and/or other battery data obtained from the sensor(s) 330 may be used to determine the remaining range 325 of the electric vehicle 300. The range 325 may be expressed as a distance (e.g., in km) and/or as a time (e.g., in hours). In some implementations, the remaining range is determined by dividing the predicted or estimated amount of energy in the motoring battery 303 (e.g., in kWh, Ah or %) by the efficiency of the vehicle (kWh/km, Ah/km or %/km, or kWh/hr, Ah/hr or %/hr). For example, the SoC 323 (in %) may be divided by the battery consumption data (in %/km or %/hr) to obtain the range 325.

The state of charge 323, the battery consumption data 324, and/or the range 325 may be communicated and presented to the operator of the electric vehicle 300 via a display 315A of the vehicle 300. Alternatively, the state of charge 323, battery consumption data 324, and/or the range 325 may be communicated and presented to the operator of the electric vehicle 300 via a personal device 315B (e.g., smartphone, laptop, etc.) of the operator. A wireless communication may therefore be established between the controller 301 of the electric vehicle 300 and the personal device 315B. This connection may be implemented by, for instance, cellular communications, Bluetooth™, WiFi™, and so on.

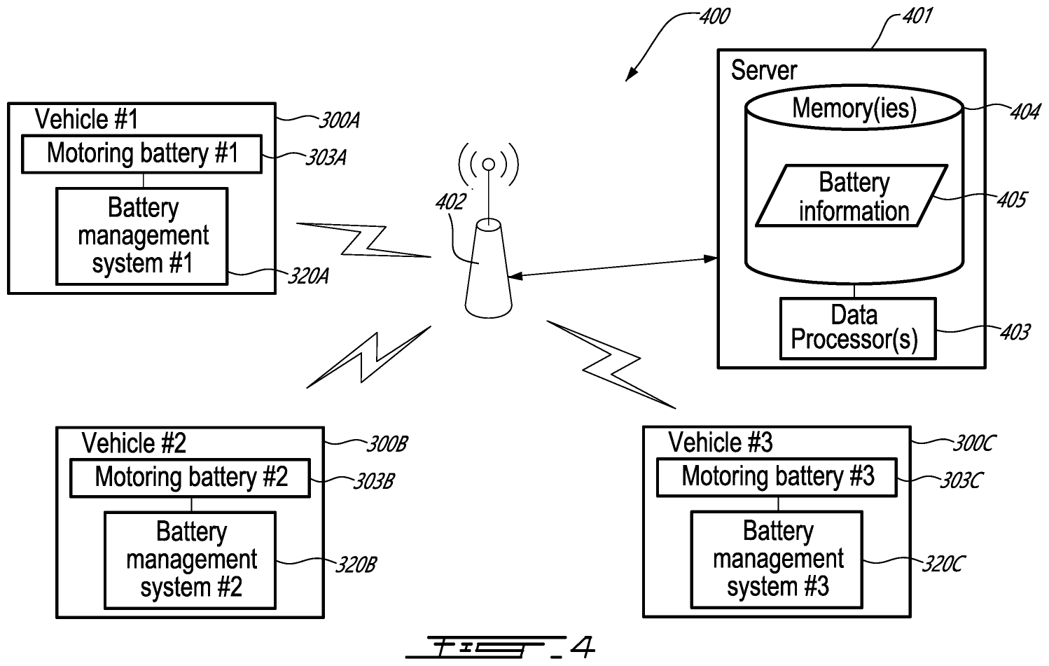

Referring now to FIG. 4, a group of electric vehicles 300A, 300B, 300C may be travelling together. For example, the electric vehicles 300A, 300B, 300C may be traveling in a similar geographic area and/or may be travelling to a common destination. Although three vehicles are shown, any suitable number of vehicles is contemplated. In some embodiments, although these vehicles travel together and may reach a common destination, driving styles of the different operators of these vehicles, variations in battery capacity of these vehicles, and so on may create discrepancies in the SoC and remaining available range of each of the vehicles 300A, 300B, 300C of the group.

The present disclosure describes methods via which the electric vehicles 300A, 300B, 300C of the group may share their respective motoring battery information and/or other data between them. For instance, an operator of a first vehicle 300A may receive motoring battery information relative to the other vehicles 300B, 300C of the group. The respective operator of the electric vehicle 300A may view, on a display associated with his or her vehicle (e.g., display 315A, personal device 315B, etc), motoring battery information pertaining to his or her vehicle compared with motoring battery information pertaining to the other electric vehicles 300B, 300C of the group. Similar comments also apply to the electric vehicles 300B, 300C, such that each operator in the group may view a summary of motoring battery information for the group. This may allow the operators of the group to see if they are depleting their battery at a faster rate than that of the other operators of the group. The operators may therefore adjust their driving style and/or select another mode of operation of the electric vehicle (e.g., range mode) such that all vehicles of the group may be able to reach a common destination or achieve some other expectation for the trip. In other words, the disclosed methods may allow the operators of each of the electric vehicles 300A, 300B, 300C to better understand how the other electric vehicles of the group are being operated.

To do so, the electric vehicles 300A, 300B, 300C of the group may be wirelessly connected to a sharing system 400. In the embodiment shown, the sharing system 400 includes a server 401 and a transmit and receive point (TRP) 402 that is wirelessly connected to each of the electric vehicles 300A, 300B, 300C of the group, herein via their respective transceiver 316 (FIG. 3A). The TRP 402 may be a base station implementing a wireless telecommunication standard such as 5G or LTE cellular communication, for example. The TRP 402 may be in wired or wireless communication with the server 401 using the internet or any other suitable communication protocol. The server 401 may be part of a cloud device, for example. The server 401 may therefore receive motoring battery information from each of the electric vehicles 300A, 300B, 300C of the group via the TRP 402 and transmit this data to the other electric vehicles of the group. Alternatively, the electric vehicles 300A, 300B, 300C of the group may be wirelessly connected together via any suitable wireless communication protocol and the server 401 may be omitted. In one example, the electric vehicles 300A, 300B, 300C may communicate with each other via the TRP 402. In another example, the electric vehicles 300A, 300B, 300C may communicate directly with each other, without the TRP 402, using Bluetooth™ communication and/or using a vehicle-to-vehicle (V2V) communication protocol.

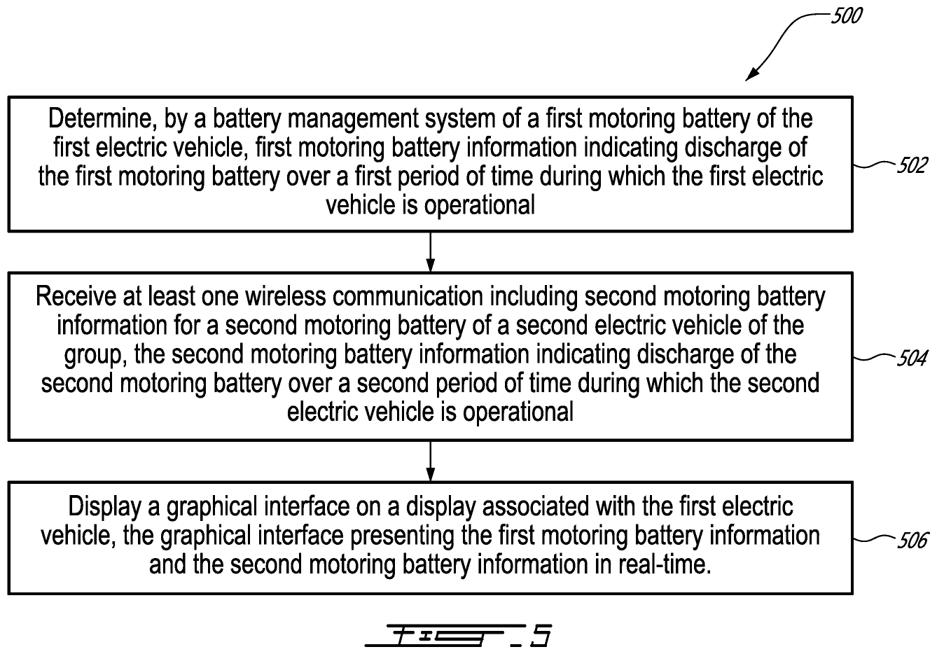

Referring now to FIG. 5 and with continued reference to FIG. 4, a method of facilitating an operation of a first electric vehicle of a group of electric vehicles is shown at 500. The method 500 may be used by the personal watercraft 10 and the snowmobile 100 described above or, more generally, by any electric vehicle. The method 500 will be described, by way of example, as being performed by the electric vehicle 300A.

The method 500 includes determining, by a battery management system 320A of the first motoring battery 303A of the first electric vehicle 300A, first motoring battery information indicating discharge of the first motoring battery 303A over a first period of time during which the first electric vehicle 300A is operational at 502; receiving at least one wireless communication including second motoring battery information for a second motoring battery 303B of a second electric vehicle 300B of the group, the second motoring battery information indicating discharge of the second motoring battery 303B over a second period of time during which the second electric vehicle 300B is operational at 504; and displaying a graphical interface on the display 315A, 315B associated with the first electric vehicle 300A at 506, where the graphical interface presents the first motoring battery information and the second motoring battery information.

In some implementations, the graphical interface may present the first motoring battery information and the second motoring battery information in real-time. Herein, the expression “real-time” may be used to refer to motoring battery information being presented on a display (e.g., at 506) responsive to determining and/or receiving the motoring battery information (e.g., at 502 and/or 504). Small delays, such as delays attributable to wireless communication protocols, data processing and so on, are considered negligible such that the information displayed at 506 represents the current battery information. In other words, the information displayed on the display 315A, 315B at 506 may provide an operator with up-to-date data regarding the electric vehicles 300A, 300B, 300C of the group.

In some implementations, the graphical interface may instantaneously present both the first motoring battery information and the second motoring battery information at 506, such that the first and second motoring battery information may be viewed by an operator simultaneously or in parallel. Herein, the expression “instantaneously” may be used to describe the display of information occurring all at one instance. In this way, by presenting the first motoring battery information and the second motoring battery information instantaneously at 506, an operator may view both the first and second motoring battery information at once. In the case that the first and second motoring battery information indicate battery discharge over a period of time, displaying this information instantaneously at 506 may allow an operator to view the discharge of the first motoring battery 303A and the second motoring battery 303B over that period of time on one display. For example, the graphical interface may include a plot illustrating the battery discharge as a function of time.

In some implementations, the first and second periods of time corresponding to when the first and the second electric are operational, respectively, may at least partially overlap one another. Optionally, the first and vehicles second periods of time are concurrent. For example, the display 315A, 315B may present the discharge of the first motoring battery 303A and the second motoring battery 303 over a same period of time.

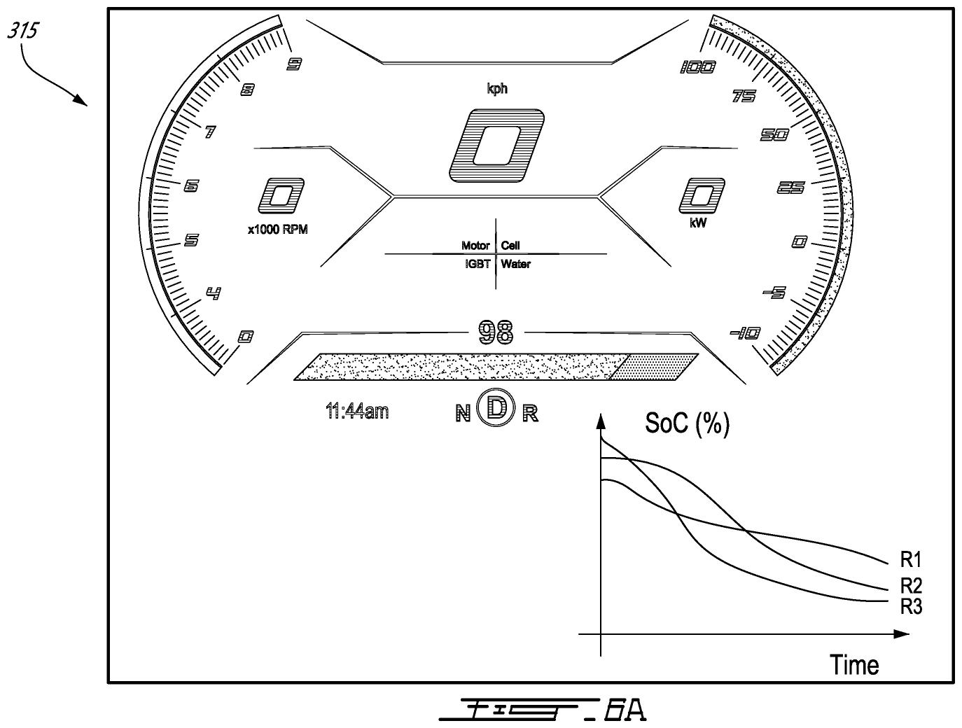

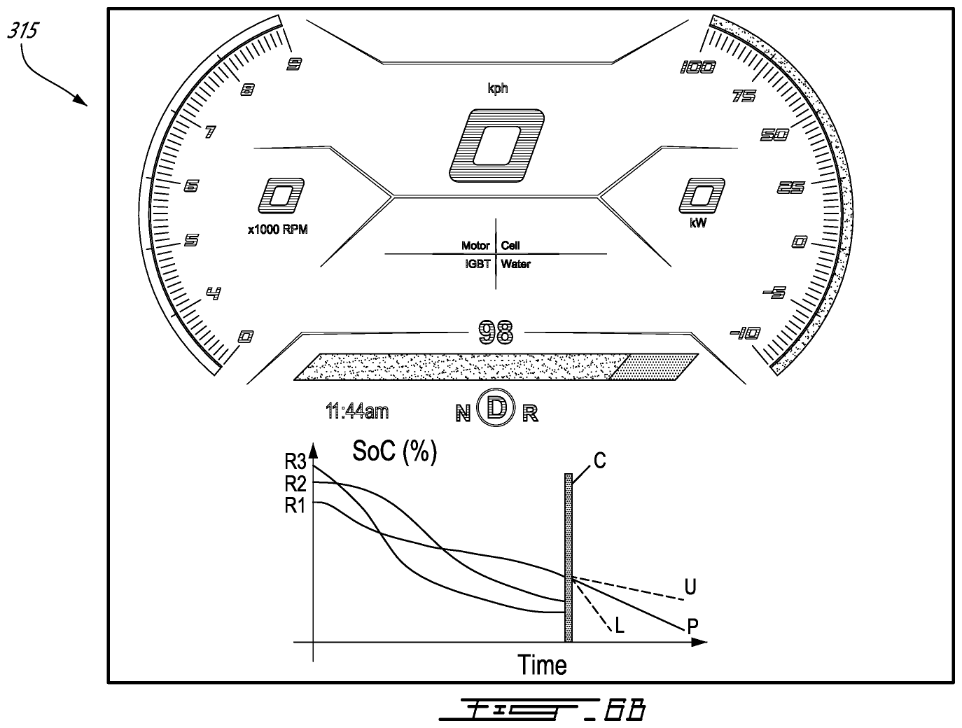

Referring to FIG. 6A, shown is an example of the graphical interface displayed at 506 in the method 500. In the embodiment shown, the displaying of the graphical interface on the display 315 associated with the first electric vehicle 300A may include plotting, on the display 315, a first curve R1 illustrating the discharge of the first motoring battery 303A and plotting, on the display 315, a second curve R2 illustrating the discharge of the second motoring battery 303B over time. A subsequent curve R3 may be plotted on the display 315 to represent motoring battery information of the third electric vehicle 300C and illustrate the discharge of a third motoring battery 303C over a period of time. Optionally, the period of time shown in the plot corresponds to a current trip involving the group of the electric vehicles 300A, 300B, 300C. The curves R1, R2, R3 may represent variation in the motoring battery information for the electric vehicles 300A, 300B, 300C, respectively, over the length of the trip. As discussed above, the curves may be plotted on the display 315A of the vehicle 300 or on a personal device 315B operatively connected to the vehicle 300. Such a connection may be a wireless connection (e.g., Bluetooth™) or a wired connection.

The graphical interface shown in FIG. 6A illustrates how an operator of the electric vehicle 300A may use the curves R1, R2, R3 to assess the amount of battery discharge and the remaining battery capacity for the group of electric vehicles 300A, 300B, 300C. For example, the most recent time points for the curves R1, R2, R3 illustrate that the motoring battery 303A has a higher SoC than the motoring batteries 303B, 303C. This may indicate that the operator of the electric vehicle 300A could consume battery capacity at a faster rate than the operators of the electric vehicles 300B, 300C without limiting the remaining length of the trip for the group. Optionally, the operator of electric vehicle 300A may choose to operate in a higher performance operating mode based on the graphical interface.

In addition, the temporal information provided by the curves R1, R2, R3, which in the illustrated example shows the decrease in SoC over time for the electric vehicles 300A, 300B, 300C, may illustrate the trends in battery capacity over the length of the trip. For example, based on the curves R1, R2, R3, the operator of electric vehicle 300A may appreciate that the electric vehicles 300B, 300C discharged their batteries at a faster rate in the first portion of the trip. This is indicated by the steeper rates of decline in curves R2, R3 at earlier time points in the plot, indicating faster rates of battery depletion. At later time points in the plot, the slope of the curves R2, R3 flattens out indicating that the electric vehicles 300B, 300C may have been driven in a relatively energy efficient manner more recently in the trip. For example, the operators of the electric vehicles 300B, 300C may have recognized that they were depleting the motoring batteries 303B, 303C faster than the operator of the electric vehicle 303A, and adjusted their driving styles and/or drive modes to compensate. Using the graphical interface of FIG. 6, the operator of the electric vehicle 300A might observe and appreciate that the electric vehicles 300B, 300C are being driven in a more energy efficient manner, and react accordingly.

As shown in FIG. 4, the method 500 may include transmitting the first motoring battery information to one or both of the other electric vehicles 300B, 300C in the group. This may be done wirelessly (e.g., via Bluetooth™). As a result, the plot shown in FIG. 6 may been shown on a respective display of each of the electric vehicles 300A, 300B, 300C. In some embodiments, each of the electric vehicles 300A, 300B, 300C of the group may be operatively connected to the server 401 via the TRP 402. The method 500 may therefore include transmitting the first motoring battery information to one or both of the electric vehicles 300B, 300C through the server 401, which may be remote from the group of electric vehicles 300A, 300B, 300C.

Alternatively, or additionally, the electric vehicles 300A, 300B, 300C of the group may be operatively connected to one another. For instance, wireless connections may be used to operatively connect together the electric vehicles 300A, 300B, 300C together. The method 500 may therefore include transmitting the first motoring battery information to the group of electric vehicles through a wireless connection defined between the electric vehicles of the group of electric vehicles. Any suitable wireless connection between the electric vehicles 300A, 300B, 300C of the group may be used. Suitable wireless connections include, for instance, Bluetooth™, WiFi™, Cellular, and so on.

In some embodiments, the method 500 may be performed repeatedly or intermittently to determine/receive further motoring battery information including more recent time points and display that further information via updated graphical interfaces. In this way, an operator may be provided with real-time information throughout their trip. By way of example, the method 500 may include determining, by the battery management system 320, third motoring battery information indicating discharge of the first motoring battery 303 over a third period of time during which the first electric vehicle 300A is operational. The third period of time occurs after the first period of time. Additionally, at least one further wireless communication including fourth motoring battery information for the second motoring battery 303B indicating discharge of the second motoring battery 303B over a fourth period of time may be received. The fourth period of time occurs after the second period of time. An updated graphical interface may be displayed on the display 315 associated with the first electric vehicle 300A. The updated graphical interface may instantaneously present the first motoring battery information, the second motoring battery information, the third motoring battery information, and the fourth motoring battery information.

The third and fourth periods of time may occur immediately after the first and second periods of time. Alternatively, a time delay may be present between the first and second periods of time and the third and fourth periods of time. In some embodiments, the displaying of the first and second monitoring battery information at 506 may be done non-continuously. For instance, the information provided on the display 315A, 315B may be updated at a given frequency (e.g., each 2 minutes) to save on battery energy. In some cases, this given frequency may be fixed. Alternatively, this given frequency may be selected by the operator. In some other cases, this given frequency may be adjusted automatically based on a rate of decrease of the state of charge of the motoring battery 303. That is, the given frequency may be increase when the rate of decrease of the state of charge is greater. This may allow the operator to more accurately follow the tendency of the state of charges of the motoring batteries of the other electric vehicles 300A, 300B, 300C of the group.

In some embodiments, the first motoring battery has a first battery capacity and the second motoring battery has a second battery capacity different from the first battery capacity. The first motoring battery information may be based on the first battery capacity and the second motoring battery information may be based on the second battery capacity.

In some embodiments, in addition to determining the first motoring battery information indicating discharge of the first motoring battery 303A over a period of time in the past (e.g., at 502), predicted motoring battery information may also be determined. This predicted motoring battery information may indicate predicted discharge of the first motoring battery 303 over a future period of time, allowing an operator to understand projections for battery discharge. In some implementations, the predicted motoring battery information may be calculated or otherwise determined based on the first motoring battery information. For example, the predicted motoring battery information may be an extrapolation of the SOC 323 of the motoring battery 303A, the battery consumption data 324 for the motoring battery 303A, and/or the current range 325 of the electric vehicle 300A into the future. In some cases, the predicted motoring battery information may be determined by the electric vehicle 300A (e.g., by the controller 301), or may be determined by the server 401.

Predicted motoring battery information may be presented via a graphical interface on the display 315 along with measured motoring battery information for the first motoring battery 303A. In some implementations, predicted motoring battery information indicating predicted discharge of the second motoring battery 303B and/or the third motoring battery 303C over a future period of time may also be determined/received and displayed on the display 315.

Referring to FIG. 6B, shown is an example of the graphical interface displaying predicted motoring battery information for the first motoring battery 303A. In the illustrated embodiment, the graphical interface on the display 315 associated with the first electric vehicle 300A includes the curves R1, R2, R3. Additionally, the graphical interface may include curves P, L, U representing predicted motoring battery information, and a line C representing the current time point on the X-axis of the plot on the graphical interface. Data points to the left of the line C may indicate measured motoring battery information, while data points to the right may represent predicted motoring battery information. In this way, the line C may help an operator differentiate between measured motoring battery information and predicted motoring battery information. Other indications, such as color and/or design differences between the curves R1, R2, R3 and the curves P, U, L, for example, may also or instead be used to help an operator differentiate between measured motoring battery information and predicted motoring battery information.

The curve P represents an example of predicted motoring battery information for the first motoring battery 303A. In some implementations, the curve P may be calculated or otherwise determined based on at least a portion of the curve R1. For example, a portion of the curve R1 may be used to determine an average discharge of the first motoring battery 303A over a certain period of time (e.g., in SOC/hr). This period of time may be a predetermined length of time representing the most recent use of the first electric vehicle 300A. As shown by the curve P, the average discharge of the first motoring battery 303A may be plotted as a linear line to depict battery usage in the future.

In some implementations, the predicted motoring battery information may indicate a range or confidence interval of predicted discharge of the first motoring battery 303A over a future period of time based on the first motoring battery information. This range is depicted by the curves L, U, which represent the lower and upper predictions for the discharge of the first motoring battery 303A, respectively. The curves L, U may be calculated or otherwise determined based on at least a portion of the curve R1. For example, the curve L may represent the lowest rate of discharge of the first motoring battery 303A during use of the first electric vehicle 300A over a period of time. Similarly, the curve U may represent the highest rate of discharge of the first motoring battery 303A during use of the first electric vehicle 300A over the period of time. In this way, a range of predicted SOC decrease over time is depicted between the curves L, U.

Although the curves P, L, U are illustrated as generally linear lines, this is only an example. In some embodiments, any, one, some or all of the curves P, L, U may be non-linear. For example, the first electric vehicle 300A and/or the server 401 may predict that the rate of discharge of the first motoring battery 303A may increase or decrease at certain times. In some cases, a change in the predicted rate of discharge of the first motoring battery 303A may be based on changes in the terrain over which the first electric vehicle 300A is traversing. If the electric vehicle is following a road, trail, or other predetermined route, then the first electric vehicle 300A and/or the server 401 may identify upcoming changes in the terrain that could change the rate of battery discharge at certain points in the trip. The curves P, L, U may then be made non-linear to depict this change in the rate of battery discharge.

As time progresses, the curves P, L, U may be updated to delete redundant data and to update predictions of battery discharge using measured motoring battery information. For example, as time progresses, portions of the curves P, L, U may be replaced with measured motoring battery information shown by the curve R1 on the graphical interface 315. Updated predicted battery information may be continuously determined and displayed on the graphical interface 315, such that the curves P, L, U extend a fixed time into the future.

In some implementations, the graphical interface shown in FIG. 6B may also include predicted motoring battery information relating to the second motoring battery 303B and/or the third motoring battery 303C. For example, the first electric vehicle 300A may determine or receive second predicted motoring battery information indicating predicted discharge of the second motoring battery 303B over a future period of time based on the second motoring battery information. The display 315 may present that data in conjunction with any, one, some or all of the curves R1, R2, R3, P, L, U. Similarly, the curves P, L, U may be presented via a graphical interface on displays of the electric vehicles 300B, 300C.

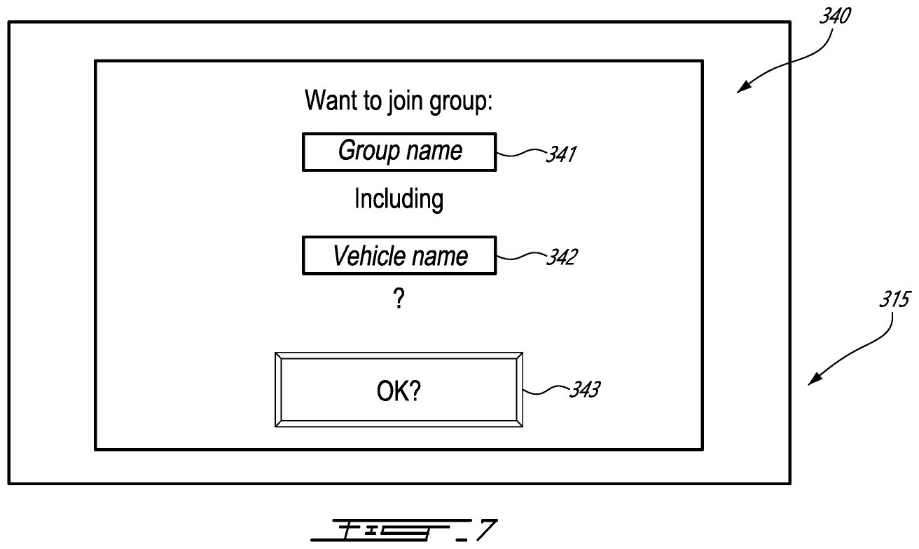

In some embodiments, the display 315 of the first electric vehicle 300A may be used by an operator to join and/or form the group of electric vehicles 300A, 300B, 300C. For example, referring now to FIG. 7, in the present embodiment, the method 500 may include receiving, from an operator interface of the display 315A of the first electric vehicle 300A, a request 340 to join and/or form the group of electric vehicles 300A, 300B, 300C. This request 340 may include an identifier 341 of the group. The identifier 341 may include, for instance, a name of the group. In some cases, the request 340 may also or instead include one or more identifier 342 of another electric vehicle 300A, 300B, 300C of the group. The operator may then press a button 343 instructing the controller 301 of the electric vehicle 300 to accept a connection to be joined to the group.

In some implementations, the operator of the electric vehicle 300A may first define the group by requesting that the other electric vehicles 300B, 300C join the group. Alternatively, a group consisting of the electric vehicles 300B, 300C may have already been formed, and the operator may request to join this existing group.

In some implementations, the server 401 may help facilitate the formation of groups of electric vehicles. For example, using satellite positioning data (e.g., global positioning system (GPS) data) from the electric vehicles 300A, 300B, 300C, the server 401 may recognize that the electric vehicles 300A, 300B, 300C are being operated in the same geographical area and may transmit an offer to one or more of the operators to form a group. Alternatively, or additionally, the electric vehicles 300A, 300B, 300C may be associated with user accounts that are stored and searchable on the server 401. The operator of the electric vehicle 300A might then search for the electric vehicles 300B, 300C to invite them to form a group. In some implementations, the server 401 might not be directly involved in forming the group, and the group might instead be formed using Bluetooth™ connections between the electric vehicles 300A, 300B, 300C, for example.

Referring to FIGS. 3A and 3B, as discussed above, the first motoring battery information may include one or more of the first current state of charge 323 (SoC) of the first motoring battery 303 and the first remaining range 325 available with the first electric vehicle 300A at the first current SoC 323. Similarly, the second motoring battery information may include one or more of a second current state of charge (SoC) of the second motoring battery 303B and a second remaining range available with the second electric vehicle 300B at the second current SoC. In some implementations, the plot shown in FIG. 6 may display the first and second remaining ranges (and, optionally, a third remaining range for the third electric vehicle 300C) in addition to, or instead of, the SoC of the first, second and third motoring batteries 303A, 303B, 303C.

In some embodiments, the first remaining range 325 may be computed by the battery management system 320. The method 500 may therefore include computing the first remaining range of the first electric vehicle 300A as a function of the first current SoC and a first distance travelled by the first electric vehicle 300A during a trip with the group, for example. Similarly, the method 500 may include computing the second remaining range of the second electric vehicle 300B as a function of the second SoC and a second distance travelled by the second electric vehicle 300B during the trip with the group. The second remaining range may be computed by the battery management system 320 of the second electric vehicle 300B and transmitted to the other electric vehicles 300A, 300C of the group. Alternatively, the second remaining range may be computed by the server 401 (FIG. 4) and communicated to the electric vehicles 300A, 300B, 300C of the group via the TRP 402.

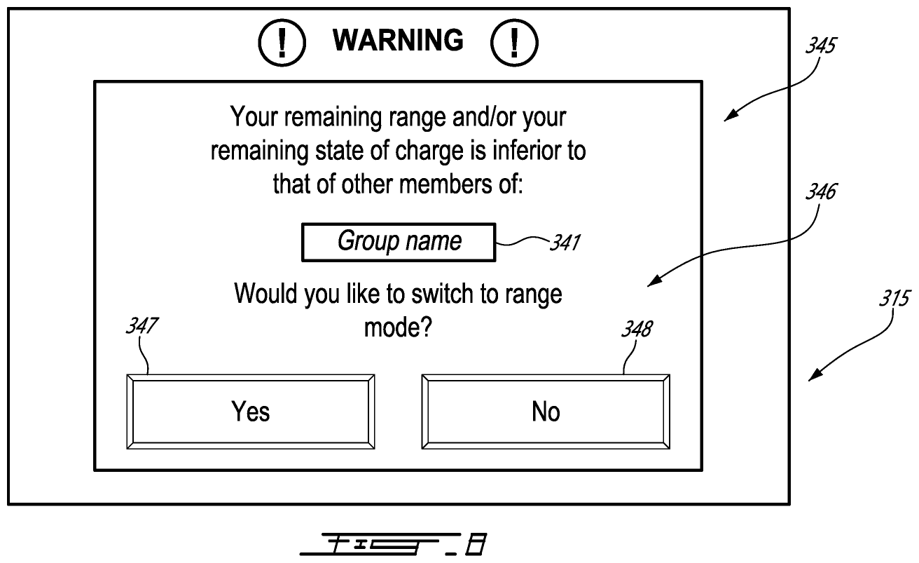

Referring now to FIG. 8, in some embodiments, the method 500 may include alerting the operator when the first current SoC 323 differs from the second current SoC by a SoC difference greater than a first threshold, and/or alerting the operator when the first remaining range 325 differs from the second remaining range by a range difference greater than a second threshold. More specifically, if the first current SoC of the first electric vehicle 300A is substantially below the SoC's of the other electric vehicles 300B, 300C of the group, it is possible that the first electric vehicle 300A does not reach the target destination of the group. The alert 345 may be presented on the display 315 associated with the first electric vehicle 300A. The alert 345 may be, for instance, a pop-up on the display 315 associated with the first electric vehicle 300A. The alert 345 may notify the operator of the first electric vehicle 300A that one or more of the remaining range 325 and the state of charge 323 is inferior (e.g., substantially less) to that of the other members of the group. The remaining ranges and/or the SoCs of the other electric vehicles 300A, 300B, 300C of the group may correspond to an average of the remaining ranges and/or the SoC's of the other electric vehicles 300A, 300B, 300C of the group.

The alerting of the operator may include a request 346 displayed on the display 315 associated with the first electric vehicle 300A. The request 346 may request the operator to select whether or not he or she wishes to switch a mode of operation of the electric vehicle from a current mode of operation to a range mode in which speed, torque and/or acceleration of the first electric vehicle 300A are limited to improve the range of the first electric vehicle 300A. The operator may, for instance, accept the change to the range mode by pressing a “Yes” button 347 or refuse and stay in the current mode by pressing a “No” button 348. Other configurations are contemplated.

Referring back to FIG. 4, the server 401 may include one or more data processors 403 and one or more non-transitory machine-readable memory(ies) 404. The memory 404 may store machine-readable instructions which, when executed by the processor 403, cause the processor 403 to perform any computer-implemented method or process described herein. In the present embodiment, the server 401 may be operable to receive battery information 405 of all of the motoring batteries 303A, 303B, 303C of the electric vehicles 300A, 300B, 300C of the group and share the battery information 405 with all of the electric vehicles 300A, 300B, 300C of the group.

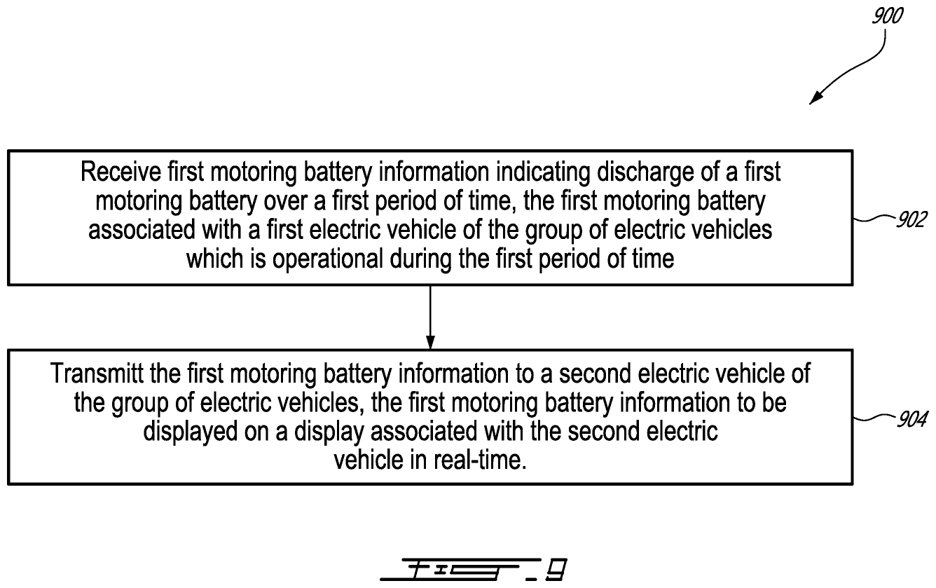

Referring to FIG. 9 and with continued reference to FIG. 4, a method of facilitating an operation of the first electric vehicle 300A of a group of electric vehicles 300A, 300B, 300C is shown at 900. The method 900 may be implemented by the server 401. The method 900 includes receiving first motoring battery information indicating discharge of the first motoring battery 303A of the first electric vehicle 300A over a first period of time at 902. The first motoring battery 303A is associated with the first electric vehicle 300A which is operational during the first period of time. The method 900 then includes transmitting the first motoring battery information to the second electric vehicle 300B of the group of electric vehicles 300A, 300B, 300C at 904. The first motoring battery information may be displayed on the display 315 associated with the second electric vehicle 300B in real-time. Optionally, the display 315 of the second electric vehicle 300B may present a plot showing the discharge of the first motoring battery 303A over the first period of time.

In some embodiments, the method 900 includes receiving second motoring battery information indicating discharge of the second motoring battery 303B over a second period of time. The second motoring battery 303B is associated with the second electric vehicle 300B which is operational during the second period of time. Then, the method 900 may include transmitting the second motoring battery information to the first electric vehicle 300A. The second motoring battery information may be displayed on the display 315 associated with the first electric vehicle 300A in real-time.

In some embodiments, the method 900 includes receiving third motoring battery information indicating discharge of the third motoring battery 303C over a third period of time. The third motoring battery 303C is associated with the third electric vehicle 300C of the group of electric vehicles which is operational during the third period of time. Then, the method 900 may include transmitting the third motoring battery information to the second electric vehicle 300B. The third motoring battery information may be instantaneously displayed with the first motoring battery information via the display 315 associated with the second electric vehicle 300B in real-time.

In the present case, the first period of time may at least partially overlap the second period of time and the first period of time may at least partially overlap the third period of time. In some cases, the first, second, and third periods of time are concurrent.

The receiving of the first motoring battery information may include receiving a first current state of charge (SoC) 323 of the first motoring battery 303A and a first distance travelled by the first electric vehicle 300A during the first period of time. The method 900 may include computing a first remaining range 325 available with the first electric vehicle 300A at the first current SoC as a function of the first current SoC and the first distance. The first remaining range 325 may be transmitted to the other electric vehicles of the group.

The receiving of the second motoring battery information may include receiving a second current state of charge (SoC) of the second motoring battery 303B and a second distance travelled by the second electric vehicle 300B during the second period of time. The method 900 may include computing a second remaining range available with the second electric vehicle 300B at the second current SoC as a function of the second current SoC and the second distance. The second remaining range may be transmitted to the other electric vehicles of the group.

The receiving of the third motoring battery information may include receiving a third current state of charge (SoC) of the third motoring battery 303C and a third distance travelled by the third electric vehicle 300C during the third period of time. The method 900 may include computing a third remaining range available with the third electric vehicle 300C at the third current SoC as a function of the third current SoC and third distance. The third remaining range may be transmitted to the other electric vehicles of the group.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A method of facilitating an operation of a first electric vehicle of a group of electric vehicles, the method comprising:
determining, by a battery management system of a first motoring battery of the first electric vehicle, first motoring battery information indicating discharge of the first motoring battery over a first period of time during which the first electric vehicle is operational;
receiving at least one wireless communication including second motoring battery information for a second motoring battery of a second electric vehicle of the group, the second motoring battery information indicating discharge of the second motoring battery over a second period of time during which the second electric vehicle is operational; and
displaying a graphical interface on a display associated with the first electric vehicle, the graphical interface presenting the first motoring battery information and the second motoring battery information in real-time.

2. The method of claim 1, wherein the displaying of the graphical interface on the display associated with the first electric vehicle includes plotting, on the display, a first curve illustrating the discharge of the first motoring battery and plotting, on the display, a second curve illustrating the discharge of the second motoring battery over time.

3. The method of claim 1, wherein the displaying of the graphical interface on the display associated with the first electric vehicle includes displaying the first motoring battery information and the second motoring battery information on a display of the first electric vehicle.

4. The method of claim 1, comprising transmitting the first motoring battery information to the group of electric vehicles.

5. The method of claim 4, wherein the transmitting of the first motoring battery information to the group of electric vehicles includes transmitting the first motoring battery information to the group of electric vehicles through a server remote from the group of electric vehicles.

6. The method of claim 4, wherein the transmitting of the first motoring battery information to the group of electric vehicles includes transmitting the first motoring battery information to the group of electric vehicles through a wireless connection defined between the electric vehicles of the group of electric vehicles.

7. The method of claim 1, wherein the first period of time at least partially overlaps with the second period of time.

8. The method of claim 1, comprising:
determining, by the battery management system, third motoring battery information indicating discharge of the first motoring battery over a third period of time during which the first electric vehicle is operational, the third period of time occurring after the first period of time;
receiving at least one further wireless communication including fourth motoring battery information for the second motoring battery indicating discharge of the second motoring battery over a fourth period of time, the fourth period of time occurring after the second period of time; and
displaying an updated graphical interface on the display associated with the first electric vehicle, the updated graphical interface instantaneously presenting the first motoring battery information, the second motoring battery information, the third motoring battery information, and the fourth motoring battery information.

9. The method of claim 1, wherein,
the first motoring battery has a first battery capacity and the second motoring battery has a second battery capacity different from the first battery capacity; and
the first motoring battery information is based on the first battery capacity and the second motoring battery information is based on the second battery capacity.

10. The method of claim 1, comprising receiving, from an operator interface of the first electric vehicle, a request to join the group of electric vehicles.

11. The method of claim 1, wherein the first motoring battery information includes one or more of a first current state of charge (SoC) of the first motoring battery and a first remaining range available with the first electric vehicle at the first current SoC, the second motoring battery information includes one or more of a second current SoC of the second motoring battery and a second remaining range available with the second electric vehicle at the second current SoC.

12. The method of claim 11, comprising one or more of:
alerting the operator, via the display, when the first current SoC differs from the second SoC by a SoC difference greater than a first threshold, and
alerting the operator, via the display, when the first remaining range differs from the second remaining range by a range difference greater than a second threshold.

13. The method of claim 12, wherein the alerting of the operator includes proposing to the operator to switch a driving mode of the first electric vehicle from a current driving mode to an extended range driving mode.

14. The method of claim 1, comprising:
determining first predicted motoring battery information of the first motoring battery, the first predicted motoring battery information indicating predicted discharge of the first motoring battery over a first future period of time based on the first motoring battery information,
wherein the graphical interface further presents the first predicted motoring battery information.

15. The method of claim 14, comprising:
determining second predicted motoring battery information of the second motoring battery, the second predicted motoring battery information indicating predicted discharge of the second motoring battery over a second future period of time based on the second motoring battery information,
wherein the graphical interface further presents the second predicted motoring battery information.

16. The method of claim 14, wherein the first predicted motoring battery information indicates a range of predicted discharge of the first motoring battery over the first future period of time based on the first motoring battery information.

17. An electric vehicle comprising:
a display;
a first motoring battery;
an electric motor for propelling the electric vehicle, the electric motor being operatively connected to be driven by electric power from the first motoring battery;
one or more data processors operatively connected to the display, the first motoring battery, and to the electric motor; and
a non-transitory machine-readable memory storing instructions executable by the one or more data processors and configured to cause the one or more data processors to:
determine first motoring battery information indicating discharge of the first motoring battery over a first period of time during which the electric vehicle is operational;
receive second motoring battery information for a second motoring battery of a second electric vehicle, the second motoring battery information indicating discharge of the second motoring battery over a second period of time during which the second electric vehicle is operational, the second electric vehicle travelling with the electric vehicle in a group of electric vehicles; and
display a graphical interface on the display, the graphical interface presenting the first motoring battery information and the second motoring battery information in real-time.

18. A method of facilitating an operation of a group of electric vehicles, the method comprising:
receiving first motoring battery information indicating discharge of a first motoring battery over a first period of time, the first motoring battery associated with a first electric vehicle of the group of electric vehicles which is operational during the first period of time; and
transmitting the first motoring battery information to a second electric vehicle of the group of electric vehicles, the first motoring battery information to be displayed on a display associated with the second electric vehicle in real-time.

19. The method of claim 18, comprising:
receiving second motoring battery information indicating discharge of a second motoring battery over a second period of time, the second motoring battery associated with the second electric vehicle which is operational during the second period of time; and
transmitting the second motoring battery information to first electric vehicle, the second motoring battery information to be displayed on a further display associated with the first electric vehicle in real-time.

20. The electric vehicle of claim 19, comprising
receiving third motoring battery information indicating discharge of a third motoring battery over a third period of time, the third motoring battery associated with a third electric vehicle of the group of electric vehicles which is operational during the third period of time; and
transmitting the third motoring battery information to the second electric vehicle, the third motoring battery information to be instantaneously displayed with the first motoring battery information on the display associated with the second electric vehicle in real-time.
